(19) United States
(12) Patent Application Publication
(10) Pub. No.: US 2007/0078789 A1
(43) Pub. Date: Apr. 5, 2007

(54) Method and system for formal contract drafting

(75) Inventor: Jonathan Griffit, Ramat Hasharon (IL)

Correspondence Address: DR. MARK FRIEDMAN LTD.;C/O BILL POLKINGHORN, 9003 FLORIN WAY, UPPER MARLBORO, MD, 20772, US

(73) Assignee: VCONTRACTS LTD

(21) Appl. No.: 11/240,496

(22) Filed: Oct. 3, 2005

(51) Int. Cl. G06Q 99/00; H04L 9/00; H04K 1/00

(52) U.S. Cl. 705/80; 705/1

(57) ABSTRACT

A system, method and computer readable code for formal contract drafting is disclosed. In some embodiments, legal directive or legal directive objects are received through a user interface, and formal contract text, such as individual contract clauses, are generated from the received legal directs or legal direct objects. In some embodiments, the user interface includes a mechanism for specifying a specific contract party, the generate clause relates to the specified party. In some embodiments, the generated clause is generating using contract logic. In some embodiments, the legal direct objects are represented by a graphical icon. In some embodiments, one generate clause is specified or derived at least in part with another generate clause. In some embodiments, the formal contract text can be presented according to one of a plurality of contract views. In some embodiments, the validity of legal directives and/or contract text is analyzed, such as, for example, by locating contradicting conditions, circular conditions and illogically redundant conditions.

### FIELD OF THE INVENTION

The present invention relates to methods, systems and computer readable code for formal contract drafting.

### BACKGROUND OF THE INVENTION

Contract drafting is a resource intensive process that often requires highly skilled yet expense legal professionals to craft clearly written agreements that fulfill the business goals of one or more of the parties entering into the contract. For many agreements one or more of the parties is liable to incur an unacceptable loss as a result of improperly crafted agreements, and thus, considerable resources are often invested in the contract drafting process.

One obstacle that needs to be overcome when drafting any agreement is the need for logical consistency within the written agreement. For complicated and intricate agreements with large numbers of clauses and multiple parties, enforcing logical consistency throughout the agreement can be an unwieldy task. Nevertheless, the risk of ambiguous agreements justifies the expenditure of countless man-hours in order to produce logically consistent formal agreements.

In order to expedite and standardize the process of contract drafting, many turn to contract wizard software for customizing standardized boilerplate agreements. These contract wizards present a finished agreement to a user as a form, and the user enters the requisite missing information into the various form fields. For simple or standardized agreements, these contract wizards allow for a certain degree of automation of the contract drafting process. Nevertheless, for many or even most contracts these form-based packages, which rely on pre-drafted agreements, do not provide the level of flexibility necessary for the generation of tailor-made agreements. In many instance users who wish to further customize these contract forms must resort to manually changing the standardized boilerplate agreements and/or manually drafting additionally clauses for the particular agreement. Thus, for many situations these contract wizards are of limited utility.

US Published Patent Application 2004/0163050 discloses a systems and methods for managing negotiated transactions. A plurality of clauses are stored and indexed and a document is created including at least one of the stored and indexed clause.

There is an ongoing need for methods, systems and computer readable code for drafting formal contract text. Preferably, these methods, system and computer readable code would include features to enable non-practitioners to draft formal contract without a need for the user to draft actual clauses. Preferably, these methods, systems and computer readable code would include a logic analyzer for analyzing contract logic and for assisting the user with the tasks of logically combining constitutive clauses and checking the document for logical consistence.

### SUMMARY OF THE INVENTION

The aforementioned needs are satisfied by several aspects of the present invention

It is now disclosed for the first time a system for formal contract drafting including an input user interface for receiving legal directive objects, and an individual clause generator for generating formal contract clauses from said legal directive objects.

In some embodiments the individual clause generator is operative to actually generate one or more clauses as opposed to only taking pre-existing clauses and putting them together to form contract text. In some embodiments, the clause generator is further operative to take a plurality of generated and/or pre-existing clauses and putting these clauses together to form contract text

According to some embodiments, the generation of the individual formal contract clauses includes generation of implicit formal contract text in accordance with the received legal directive objects.

According to some embodiments, the implicit formal contract text is generated within the individual generated clauses.

According to some embodiments, contract clauses are generated using contract logic embedded in the clause generator. In one example, “contract logic” includes generation of implicit formal contract text within a single clause that is logically consistent (in term of “rules” of formal contract text) with received legal directives. In one example, “generation of clauses using contract logic” includes identify or even correcting logically inconsistencies within the general formal contract text. In one example, “generation of clauses using contract logic” includes requesting missing requisite elements within a clause, or offering suggestions and generating the clause in accordance with the suggestions.

According to some embodiments, the interface includes a legal directive object template defining optional or requisite objects of an individual contract clause.

Appropriate legal directive objects include but are not limited to action objects, modifier objects, quantity directive objects, quantity unit directive objects, delivery directive objects, time objects, date objects, and legal condition objects.

Appropriate legal action objects include but are not limited to product object (e.g. simple product objects or complex product objects), payment objects (e.g. for specifying payment methods, payment amounts, and payment means).

According to some embodiments, the contract includes a plurality of contract parties. For example, in an employment contract the parties are “Employer” and “Employee”. In a simple sales contract, the parties can include “Buyer” and “Seller.” In a rental contract, the parties are “Tenant” and “Landlord.” In some contracts, there are more than two contract parties.

According to some embodiments, the input user interface provides a mechanism for selecting an active contract party from a plurality of said contract parties (e.g. including but not limited a dedicate active party selection mechanism such as a selectable tab), and the generated clause relates to an active contract party (e.g. a subject of the generated clause is the active contract party). According to some embodiments, there is no need to further specify the active party for generation of the clause once the active party has been selected through the mechanism (e.g. dedicate contract party selection mechanism).

Thus, in one example, if “Buyer” is selected, and then a penalties object is selected, the penalties in a clause generated would relate to penalties for late payment. In a related example, if “Seller” is selected, and a penalties object is selected, then penalties would relate, for example, to a product of low quality or a late delivered product.

In another example, if “Buyer” is selected, then a first menu of legal directive objects would be presented to a user (e.g. a menu describing buyer commitments such as a menu including a payment object describing terms of payment that the buyer commits himself to). If a “Seller” is selected, then a second menu of legal directive objects would be presented to a user (e.g. a menu including seller commitments such as a delivery time of goods).

According to some embodiments, the legal condition object is a logical condition operator. Exemplary logical condition operators include but are not limited to quantity condition operators, quantity comparison condition operators (e.g. smaller than, greater than, equal to), conditional operators (in case . . . , etc) a time condition operator (e.g. later than, later than stated, sooner than, sooner than stated), and a size condition operator (e.g. bigger than, smaller than).

According to some embodiments, the generated clause is selected from the group consisting of an action clause (e.g. buyer X agrees to buy product Y from seller Z), a condition clause (e.g. if delivery is more than 3 months late, seller agrees to reduce the price by 20%) and a finalization clause.

According to some embodiments, at least one legal directive object is definable using a legal object definition form.

According to some embodiments, at least one legal directive object is represented in the input user interface by a graphical icon.

According to some embodiments, dragging of a graphical icon sends information to the individual clause generator for the clause generation.

According to some embodiments, the clause generator is operative to derive at least one contract clause from at least one other contract clause. According to some embodiments, the derivation is effected using contract logic. In one example, a Seller agrees to sell a product to a buyer with payment terms of payment 90 days after delivery (as opposed to, for example, 30 or 60 days). The seller has many clients, all of whom have different credit ratings. If the Buyer has a good credit rating, a clause reciting a penalty of 5% if payment is late is generated (for the example where the payment is 30 days, the payment would, for example, be 2%). According to this example, the Buyer has mediocre credit, a clause reciting a penalty of 8% if payment is late is generated (for the example where the payment is 30 days, the payment would, for example, be 4%).

According to some embodiments, a derived contract clause is a finalization clause. Thus, in one example, after a system presents menus to specify buyer and seller, a separate “Finalization” clause is generated (see FIG. 240) providing a listing of sides to the agreement.

According to some embodiments, the clause generator is operative to include within the derived clause a condition dependent on at least one other contract clause. Thus, in one example, the system in a sale contract must include a clause for late penalty. If clause (e.g. time of payment) is 30 days after delivery, the separate clause for late penalty automatically includes one type of penalty (e.g. 3% penalty). If clause (e.g. time of payment) is 60 days after delivery, the separate clause for late penalty automatically includes one type of penalty (e.g. 6% penalty).

According to some embodiments, at least one said legal directive object is selectable from a plurality of legal directive objects.

According to some embodiments, the presently disclosed system further includes contract logic analyzer for analyzing validity of at least one of a received legal directive object, generated contract clauses and built formal contract text.

According to some embodiments, the system further includes a formal contract text builder for building formal contract text (e.g. such as an entire contract) from a plurality of said generated contract clauses.

Thus, in one example, individual generated contract clauses are combined, and appropriate text relating the individual generated clauses to each other are included in the text.

According to some embodiments, the formal contract document builder includes a finalization engine for generating finalization clauses of said formal contract document.

According to some embodiments, the system further includes a contract text view presenter for presenting legal text related to the generated contract clause in accordance with a presentation view selectable from a plurality of contract text presentation views.

According to some embodiments, at least one contract text view is selected from the group consisting of a view mixing icons and numbers, a view mixing icons and text, an informal text view, a colored informal text view, and a business logic view. Thus, in one example, the system provides a mechanism for toggling between these views. Thus, in a non-limiting example, a businessman negotiating a deal prefers the “business logic view” or “informal text view” which obviates the need for this businessman to handle formal legal text, while the legal counsel uses a view which presents the formal contract text. It is noted that According to some embodiments, the system is configurable so that additional views may be defined.

According to some embodiments, the business logic view includes at least one of a time line graph, and a profit graph.

According to some embodiments, the contract text presenter is operative to present the formal contract text according to formalities of a jurisdiction selectable from a plurality of jurisdictions.

According to some embodiments, the system further includes a contract logic engine for analyzing contract logic associated with at least one of the received legal directive objects and the generated clause.

According to some embodiments, the system further includes a contract validity engine for to identifying legally invalid or potentially invalid contract elements associated with the formal contract text.

Exemplary invalid contract elements include but are not limited to contradicting conditions, circular conditions, an inappropriate contract party, and illogically redundant conditions.

According to some embodiments, the system further includes a scenario analysis engine for facilitating scenario analysis in accordance with received legal directive objects or candidate legal directive objects. Candidate legal directive objects are objects presented to the user for consideration but which have not been submitted by the user to the system.

According to some embodiments, the system further includes a suggestion engine for generating suggestions selected from the group consisting of suggested clauses and suggested legal directive objects.

It is now disclosed for the first time a method of formal of contract drafting. The presently disclosed method includes (i) receiving through a user interface a specification of a plurality of legal directive objects and (ii) generating at least one individual formal contract clause from the legal directive objects.

It is now disclosed for the first time a system for formal contract drafting. The presently disclosed system includes (i) an input user interface for receiving legal directives; and (ii) a formal contract text generator for generating formal contract text from said received legal directives using contract logic.

It is now disclosed for the first time a method of formal of contract drafting. The presently disclosed method includes (i) receiving through a user interface a specification of a plurality of legal directive objects, and (ii) using contract logic to generate formal contract text from the received legal directives.

It is now disclosed for the first time a system for formal contract drafting of a contract having a plurality of said contract parties. The presently disclosed system includes (i) a contract party selection mechanism for selecting an active contract party from the plurality of contract parties; (ii) a input user interface for receiving legal directives, at least one legal directive adapted in accordance with the selected active contract party, and (iii) a formal contract text generator for generating formal contract text from the received legal directives including said adapted at least one legal directive.

According to some embodiments, the adapting of the legal directive includes requiring that a subject of a clause related to the adapted legal directive is the selected active contract party.

It is now disclosed for the first time a method of formal of contract drafting. The presently disclosed method includes (i) receiving a selection of an active contract party from a plurality of contract parties; (ii) receiving through a user interface a specification of a plurality of legal directive objects, (iii) adapting at least one legal directive object to the selected active contract party; and (iv) generating formal contract text from the received legal directives including the adapted at least one legal directive.

It is now disclosed for the first time a system for formal contract drafting. The presently disclosed system includes (i) a input user interface for specifying legal directives, at least one said legal directive represented by a graphical icon, and (ii) a formal contract text generator for generating formal contract text from the specified legal directives.

It is now disclosed for the first time a method of formal of contract drafting. The presently disclosed method includes (i) receiving through a user interface a specification of a plurality of legal directive objects, at least one said legal directive represented by a graphical icon, and (ii) generating formal contract text from said specified legal directives.

It is now disclosed for the first time a system for analyzing validity of contract text, the system. The presently disclosed system includes (i) a store configured to store a representation of formal contract text and (ii) a contract text validity analyzer for determining a validity of the received formal contract text.

According to some embodiments, the “representation of formal contract text” is actual formal text.

According to some embodiments, the analyzer is operative to identify at least one of contradicting conditions, circular conditions, an inappropriate contract party and illogically redundant conditions within the formal contract text.

It is now disclosed for the first time a method of formal of contract drafting. The presently disclosed method includes (i) receiving a representation of formal contract text and (ii) determining a validity of received formal contract text.

According to some embodiments, the determining of the validity includes identifying at least one of contradicting conditions, circular conditions, an inappropriate contract party and illogically redundant conditions within the formal contract text.

It is now disclosed for the first time a computer readable storage medium having computer readable code embodied in the computer readable storage medium. The presently disclosed computer readable code includes instructions for receiving through a user interface a specification of a plurality of legal directive objects and generating at least one individual formal contract clause from said legal directive objects.

These and further embodiments will be apparent from the detailed description and examples that follow.

### BRIEF DESCRIPTION OF THE DRAWINGS

FIG. 1 provides a figure describing an exemplary format of a formal contract.

FIG. 2 provides a figure describing an exemplary formal contract.

FIG. 3 provides a block diagram describing exemplary embodiments of the present invention.

FIGS. 20-340 provide images of a user interface in accordance with some embodiments of the present invention.

### DETAILED DESCRIPTION OF THE INVENTION

The present invention will now be described in terms of specific, example embodiments. It is to be understood that the invention is not limited to the example embodiments disclosed. It should also be understood that not every feature of the method and system for generating formal contract text is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

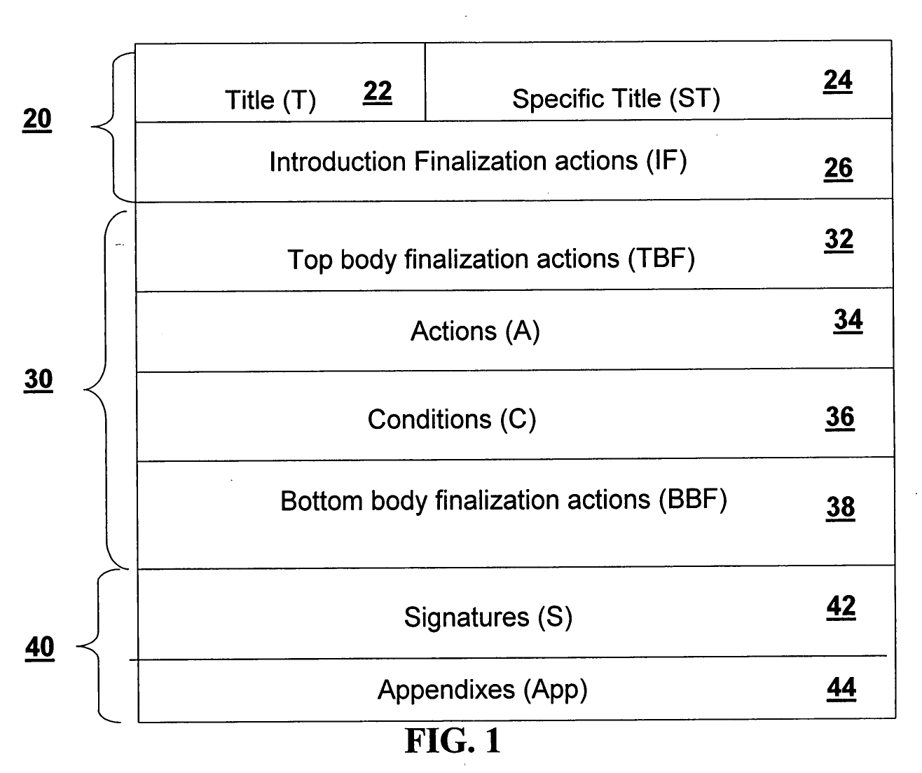

In accordance with some embodiments of the present invention, the present inventor has determined that many formal contracts may be described according to the exemplary schematic diagram provided in FIG. 1. According to FIG. 1, each formal contract includes one or more of the following: An Introduction Section 20, A body section 30, and a conclusion section 40.

The Introduction Section 20 has one or more of a Title (T) 22, a Specific Title (ST) 24, and Introduction Finalization Actions 26. For the specific example of a contract drawn to sale of goods, an exemplary Title 22 is “Agreement” or “Contract” while an exemplary specific title 24 is “contract for sale of goods” or “investment agreement”.

Each of these sections includes one or more constitutive sub-sections as illustrated in FIG. 1.

Generally, actions 34 involve taking action such as transfer, assignment of rights and/or obligations concerning products, processes, etc. Generally, conditions 36 are clauses including conditions and terms.

The body section 30 has one or more of Top Body Finalization Actions (TBF) 32, clauses including actions 34 and/or conditions 36, and bottom body finalization actions (BBF) 38.

The conclusion section 40 including one or more of appended signatures 42 and appendices 44.

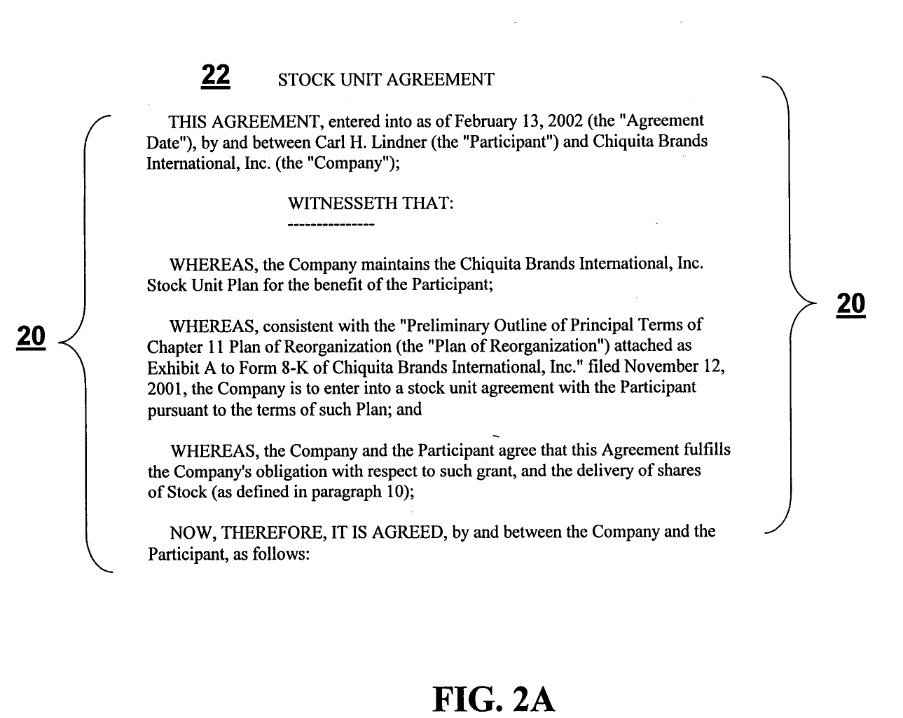

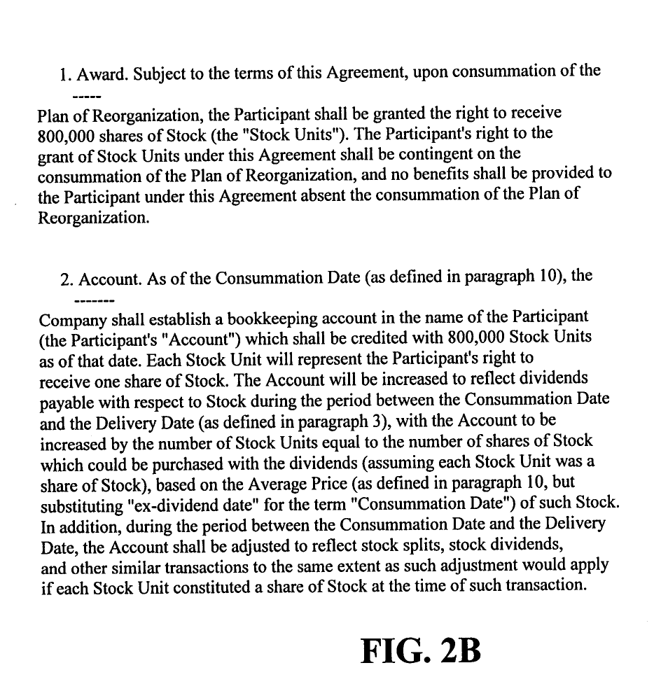

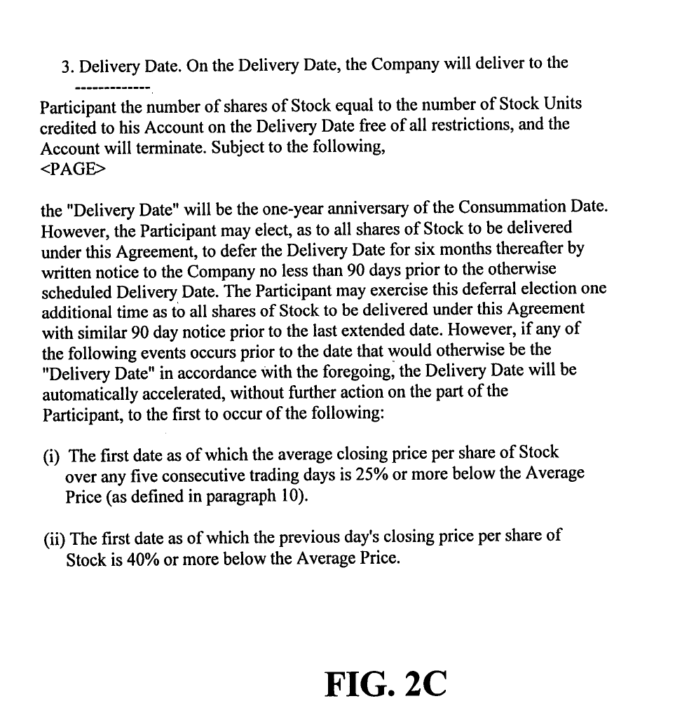

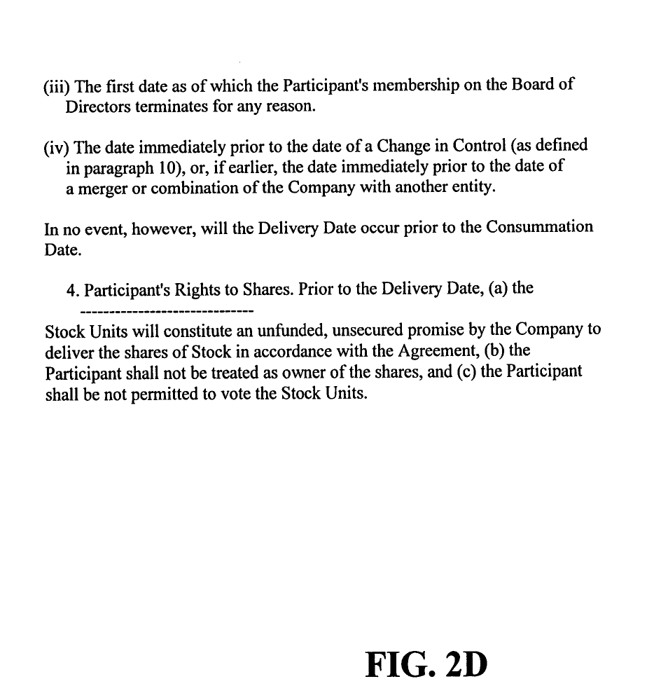

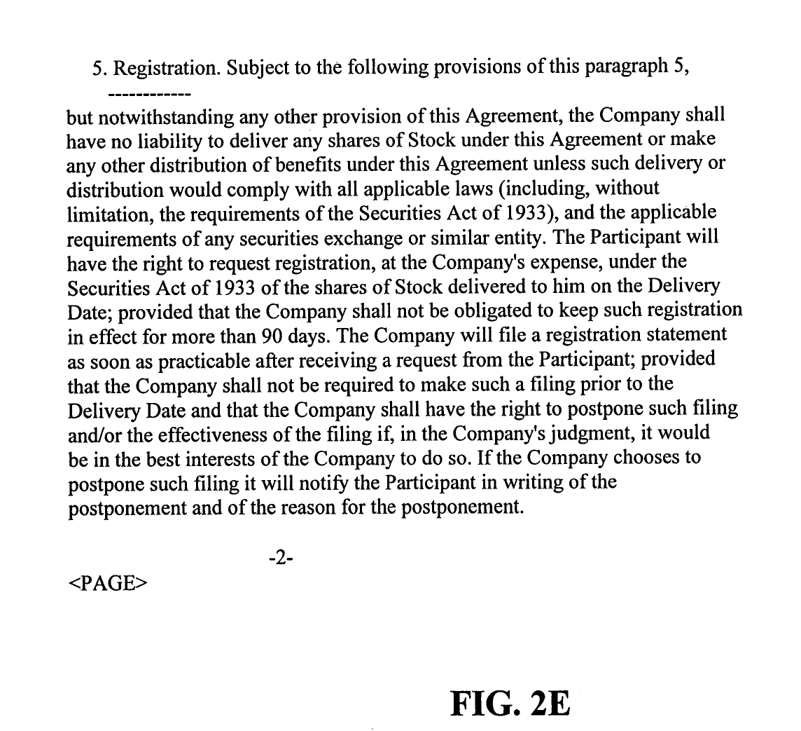

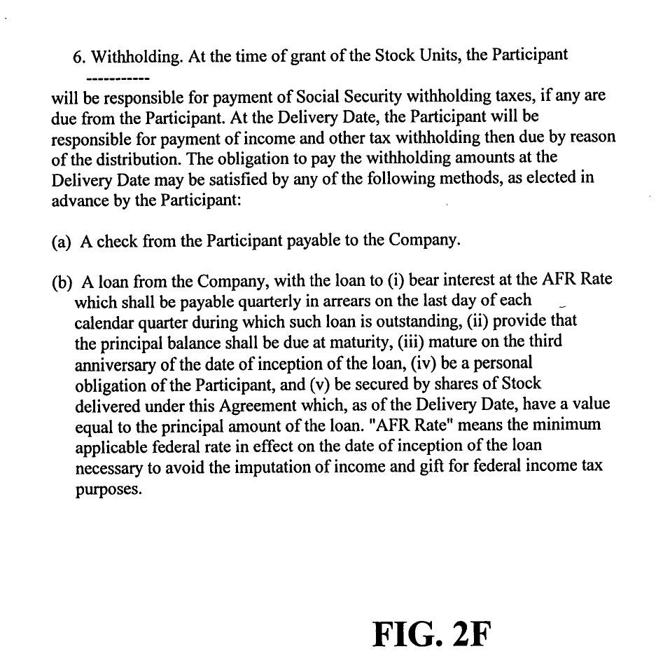

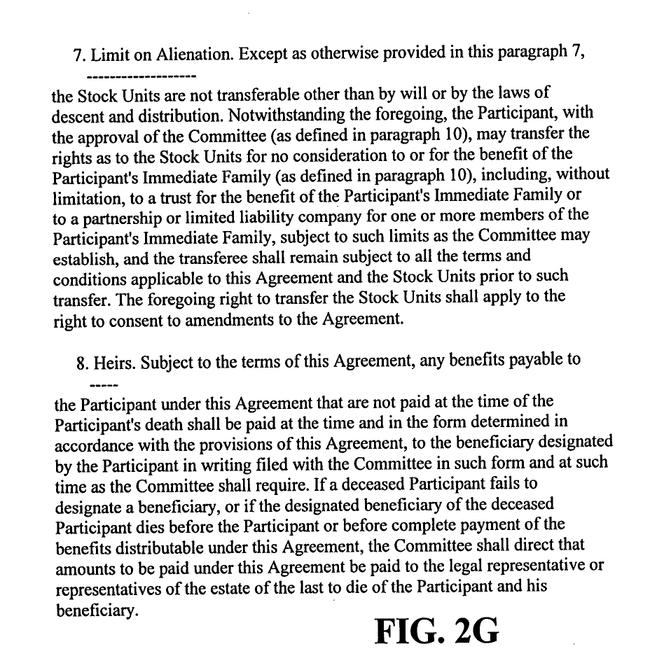

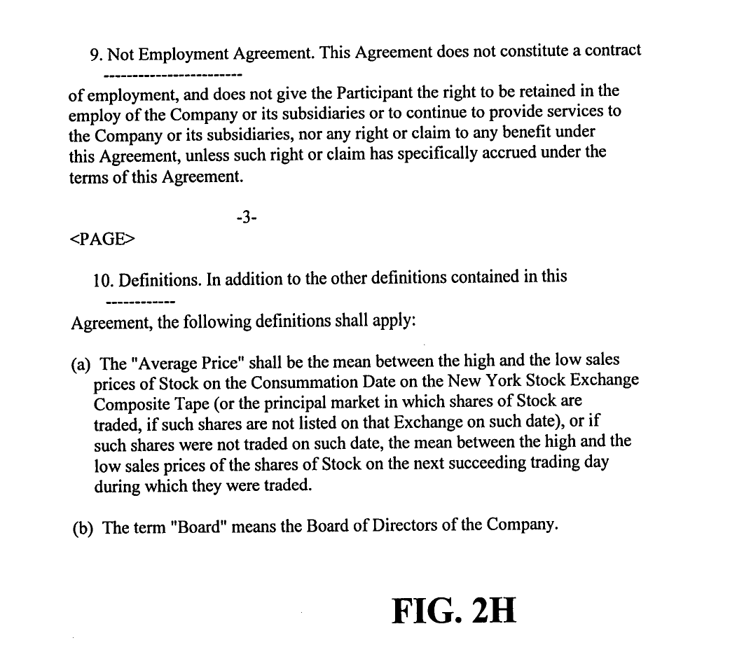

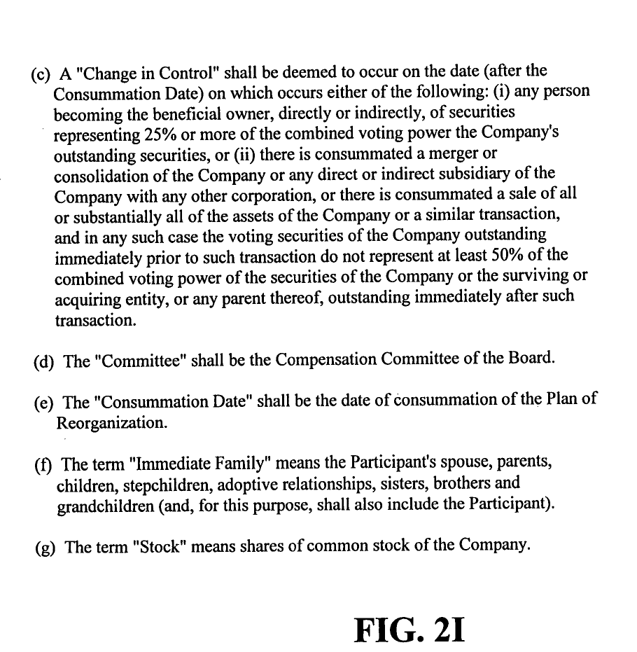

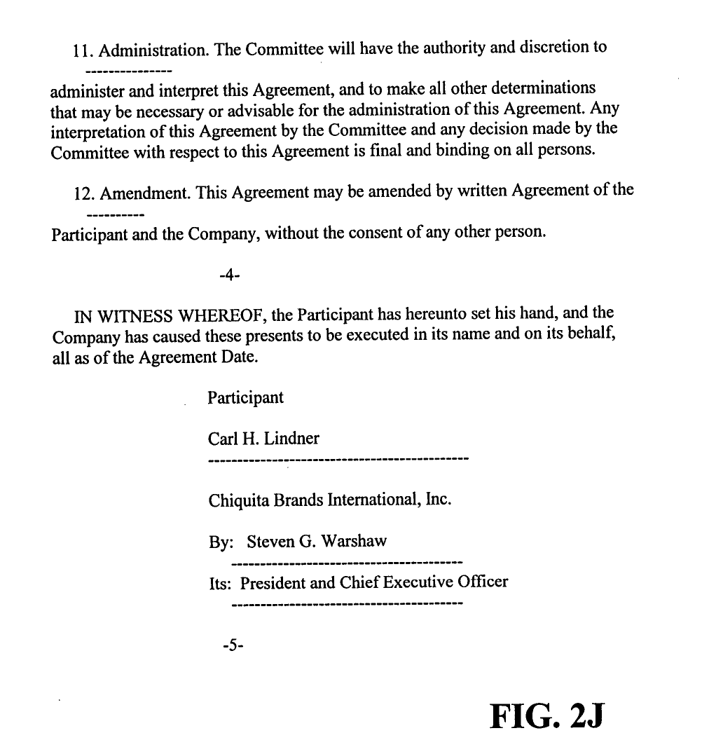

FIG. 2 provides an image of an exemplary formal contract whose sections are labeled according to the terms described in FIG. 1.

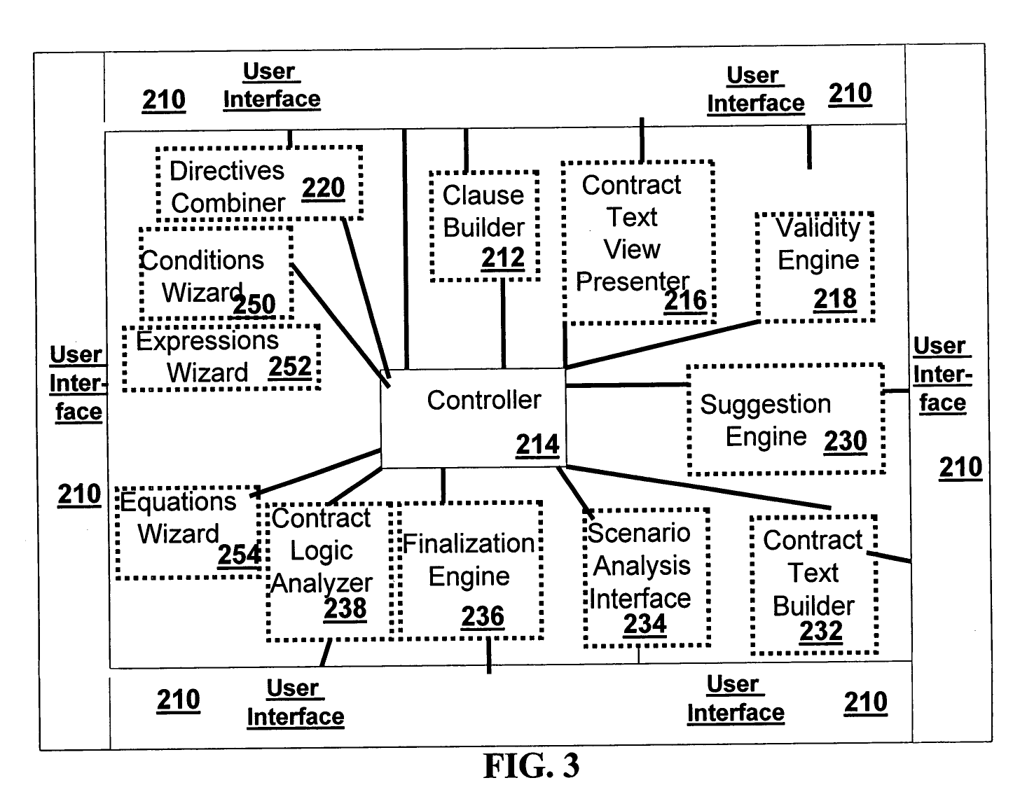

FIG. 3 provides a block diagram of various exemplary components according to some embodiments of the present invention. The various components may communicate with each other and work together through a controller 214.

A user interface 210 is operative to receive legal directives or legal directives objects. The optional clause builder 212 generates one or more contract clauses from the received legal directives or legal directives objects. Optionally, the directives combiner 220 combined received legal directives or legal directives objects to create formal contract text.

In some embodiments, the optional contract text view presenter 216 presents formal contract text according to a contract view such as simple text, legal text, text compliant with one or more jurisdictions, and any other appropriate view. Optionally, the system includes a validity engine 218 which uses contract logic to analyze validity of formal contract text.

Optionally, system includes a suggestion engine 230 for supplying suggestions in accordance with received legal directives or legal directive objects. Furthermore, as shown in FIG. 232 the system includes an optional contract text builder 232 for building formal contract text and/or one or more clauses for received legal directives or directive objects. The system optionally includes a scenario analysis interface 234 for presenting and/or receiving scenarios and allowing a user to analysis variations of a proposed contract. Optionally, the system includes a finalization engine 236 for generating customized finalization clauses. It is noted that in some embodiments, unlike a mere interface for collating received text, the system of the present invention is operative to actually analyze the contract logic of received text and/or legal object directives using the optional contract logic analyzer 238.

Furthermore, according to some embodiments the system includes an optional expressions wizard 252 for formulating legal expressions and/or business expressions according to representative icons. One non-limiting example of a business expression is a directive to buy or sell a financial instrument (e.g. stock or bond) short under certain conditions specified by the business expression. In this non-limiting example, the system can generate the appropriate legal expression from the specified business expression.

Optionally, the expressions wizard includes a customizable synonyms engine which is operative to store customized synonyms list and to replace certain synonyms with other synonyms throughout one or more clauses and/or one or more sections of the formal contract text. It is noted that in many situations it is important to use the same term rather than various synonyms for the sake of consistency, and the synonym wizard allows for enforcement of the requisite term consistency.

In some embodiments, the system includes a conditions 250 wizard for handling legal directives or legal directive objects that represent conditions. This allows for combining legal directives or legal directive objects within a clause to generate a conditional clause or between clauses.

In some embodiments, the system optionally includes an equations wizard for calculating relevant numbers to be included in generated formal contract text.

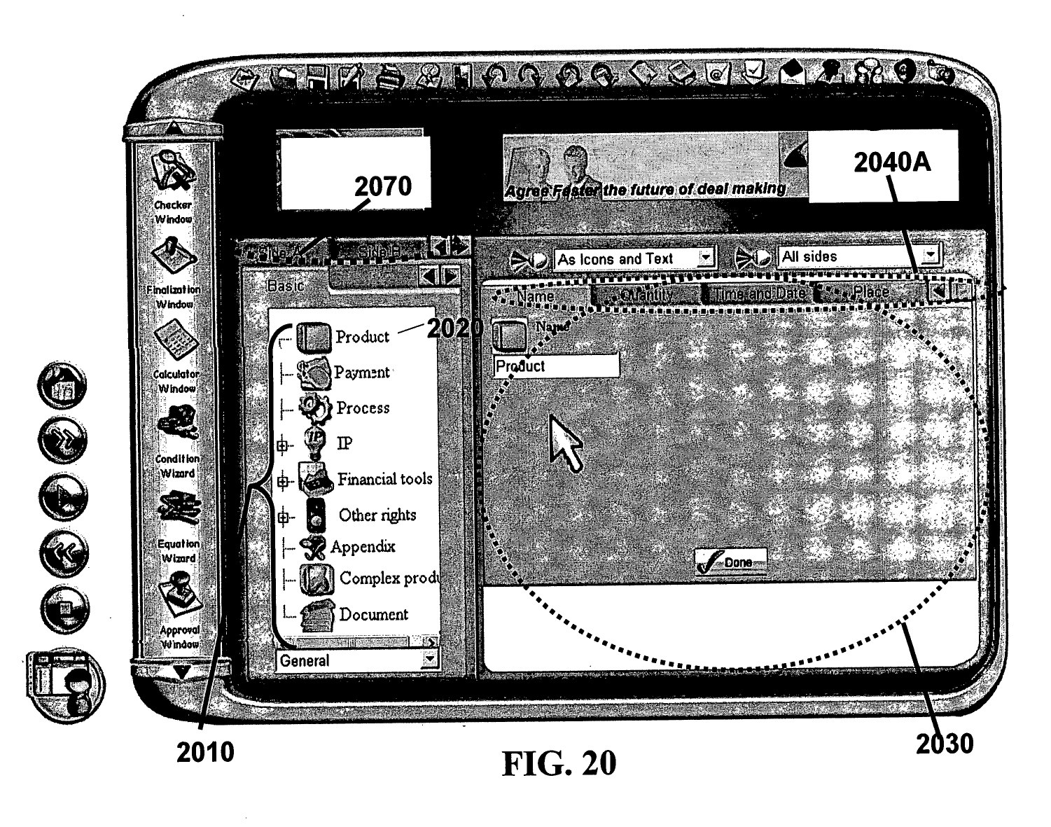

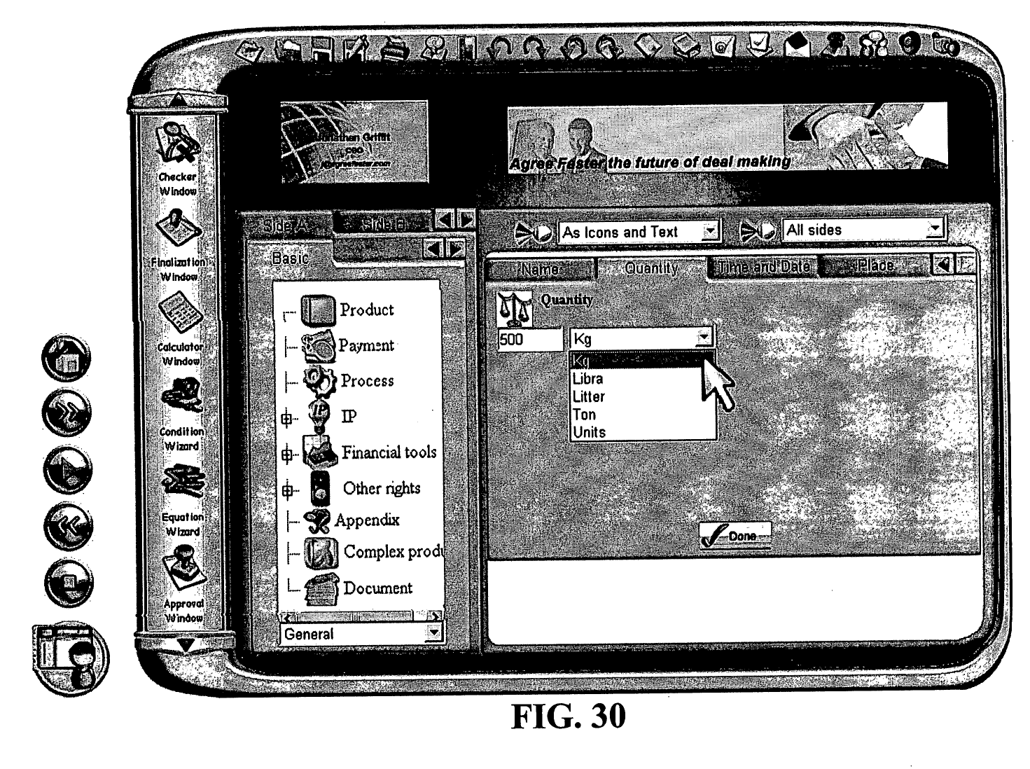

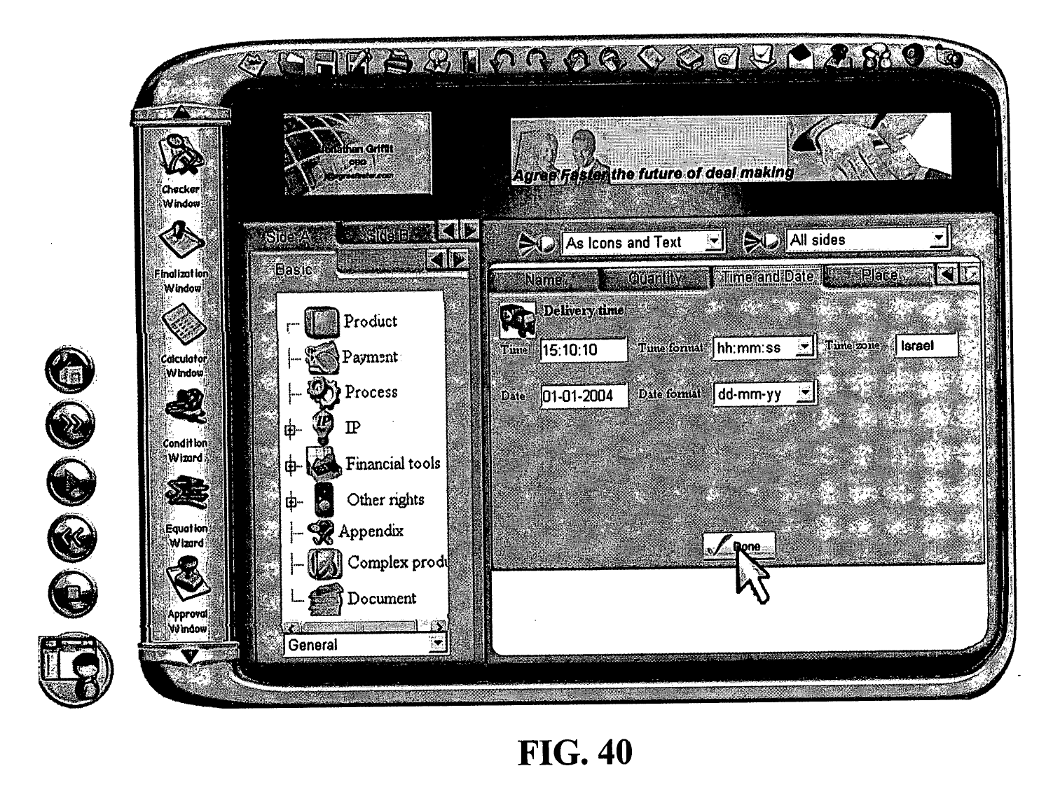

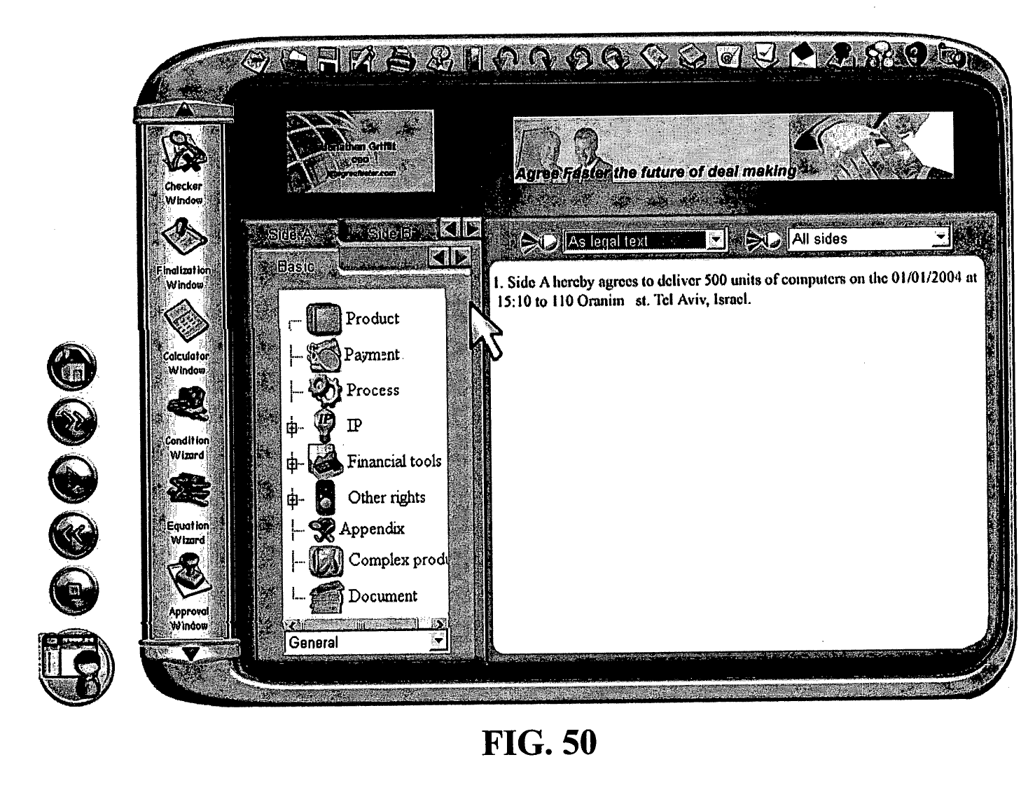

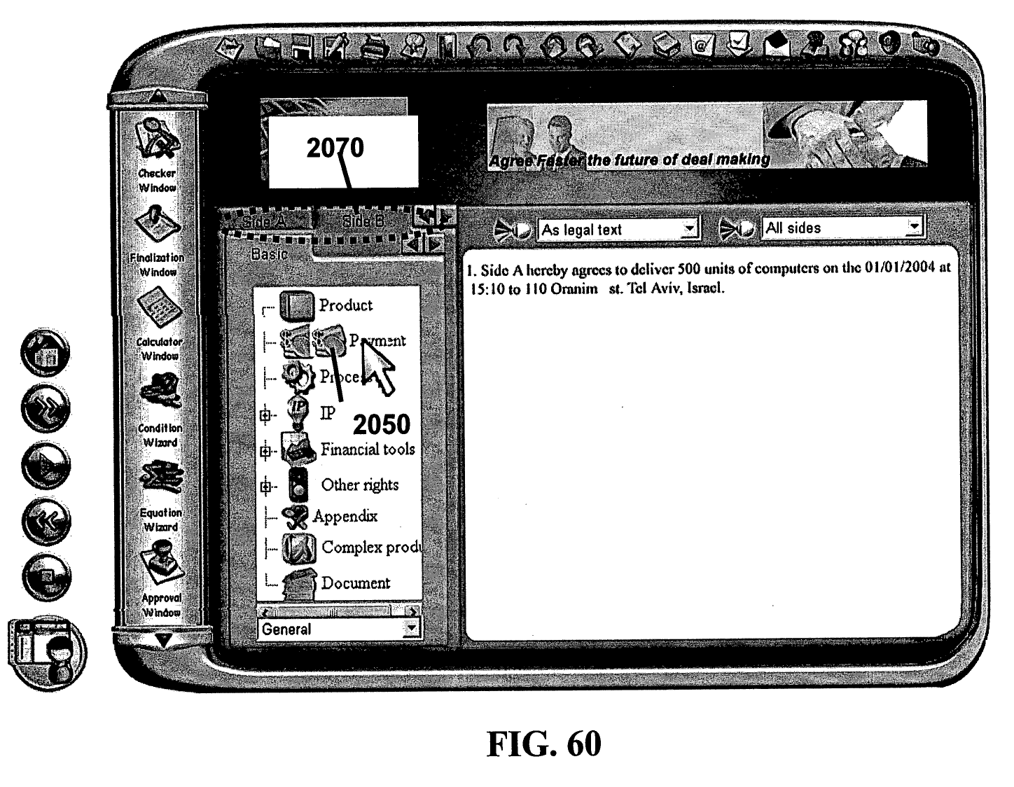

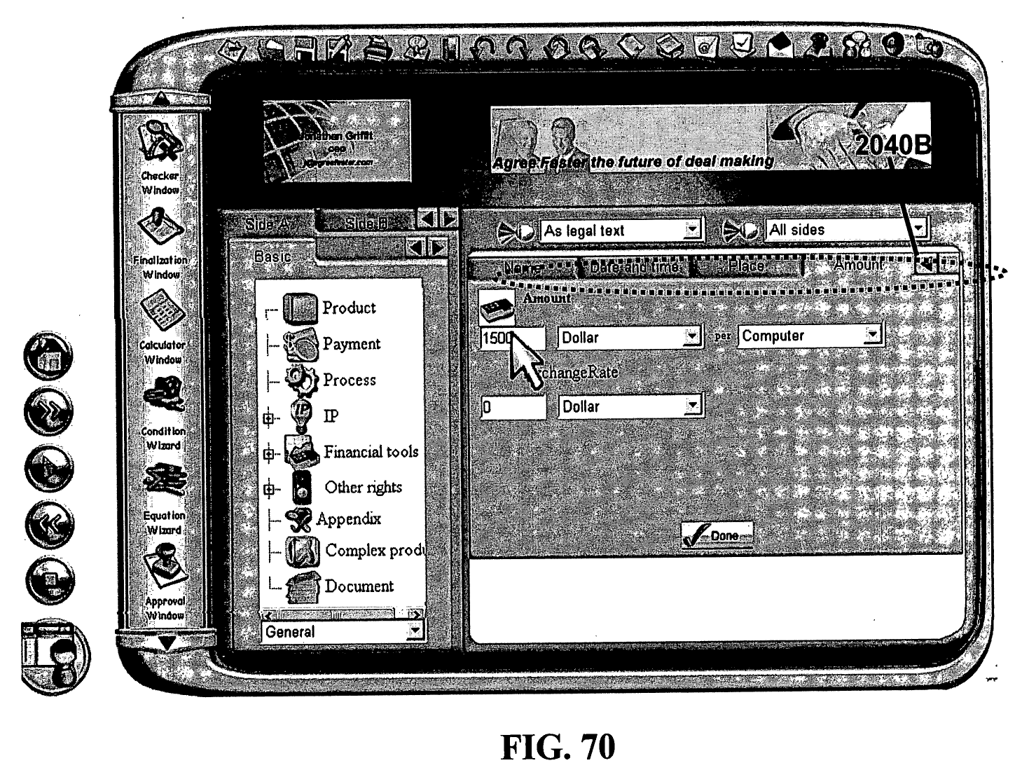

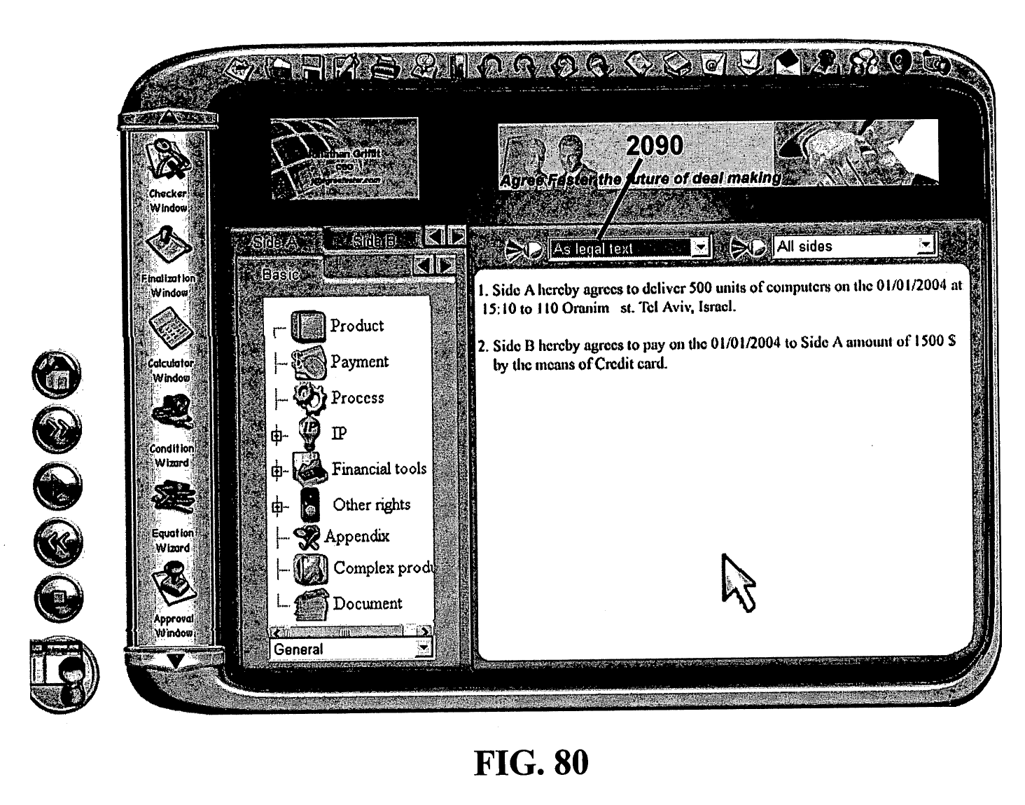

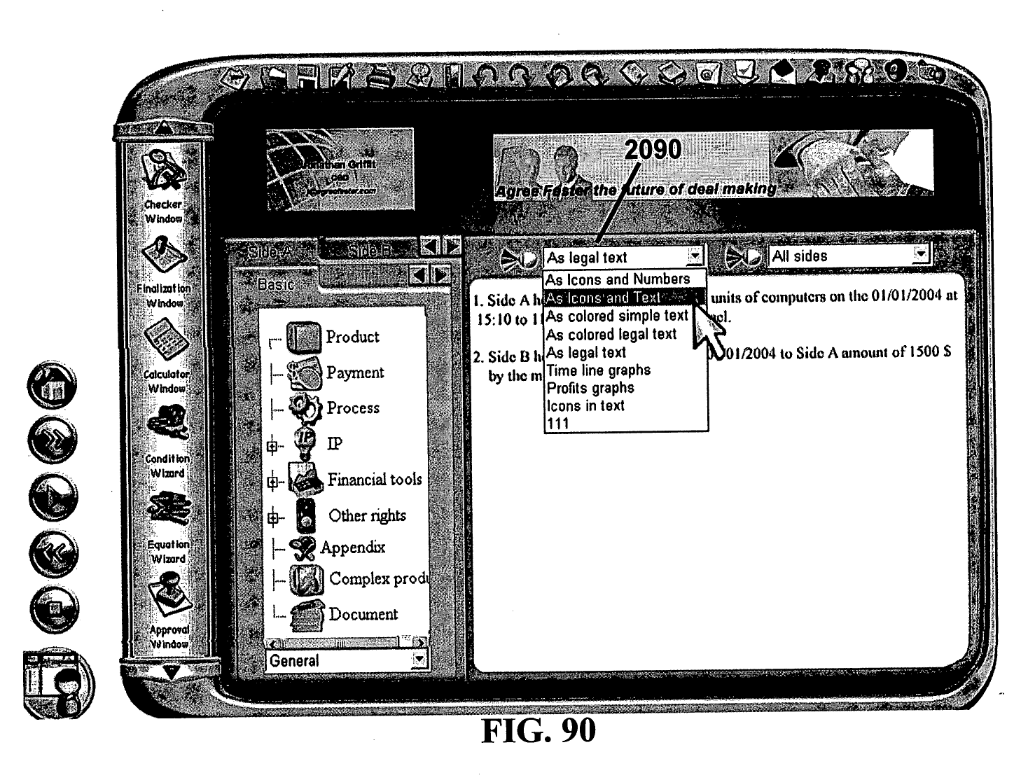

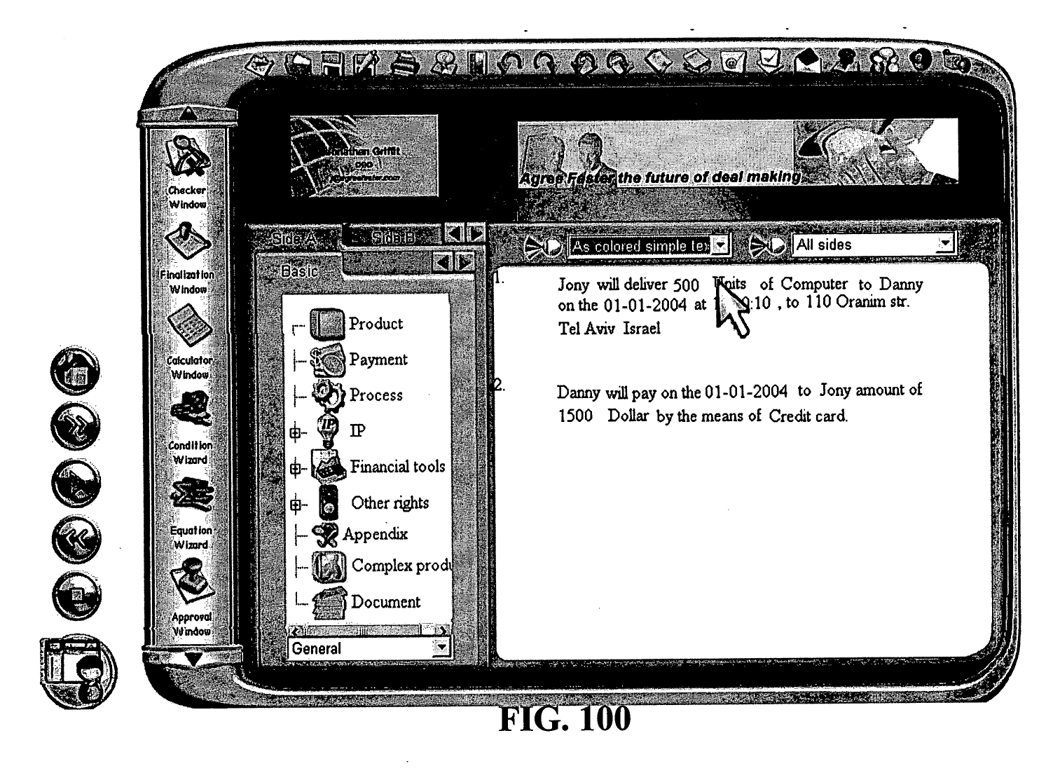

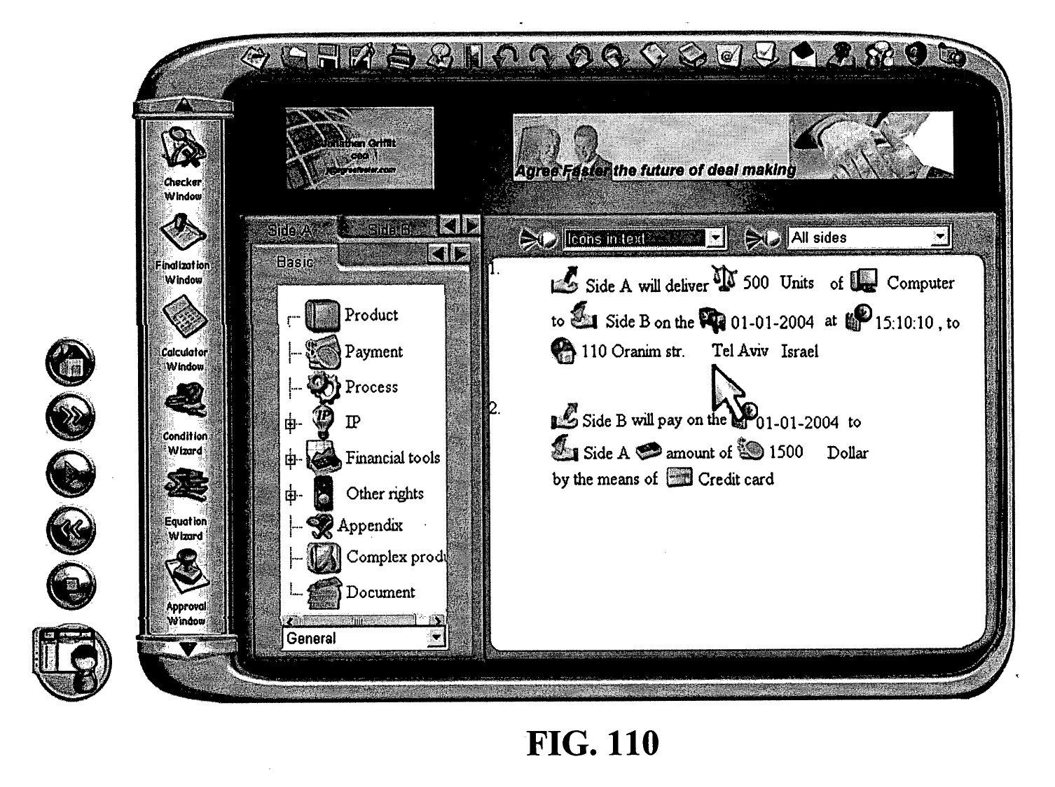

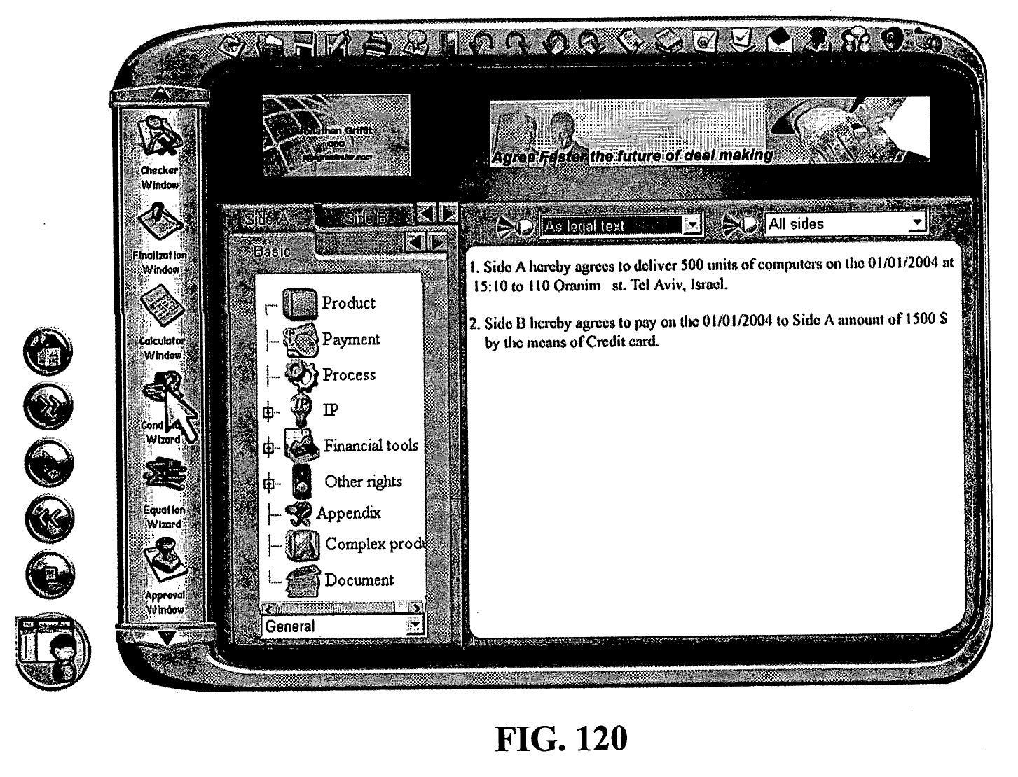

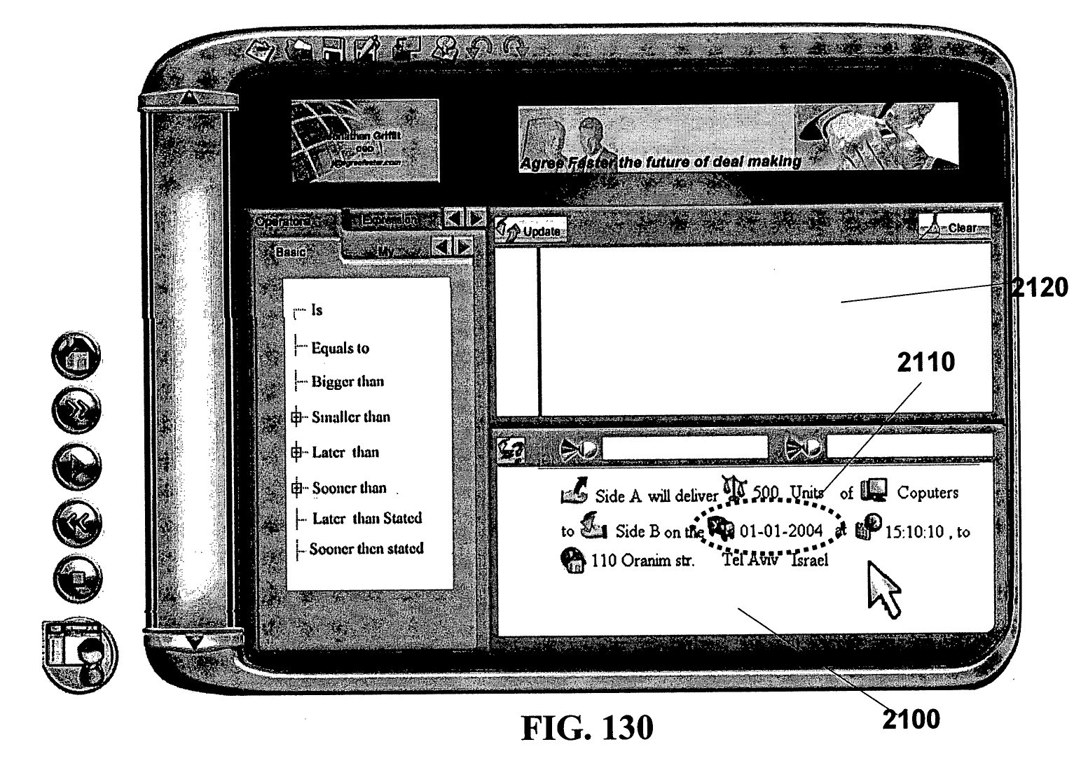

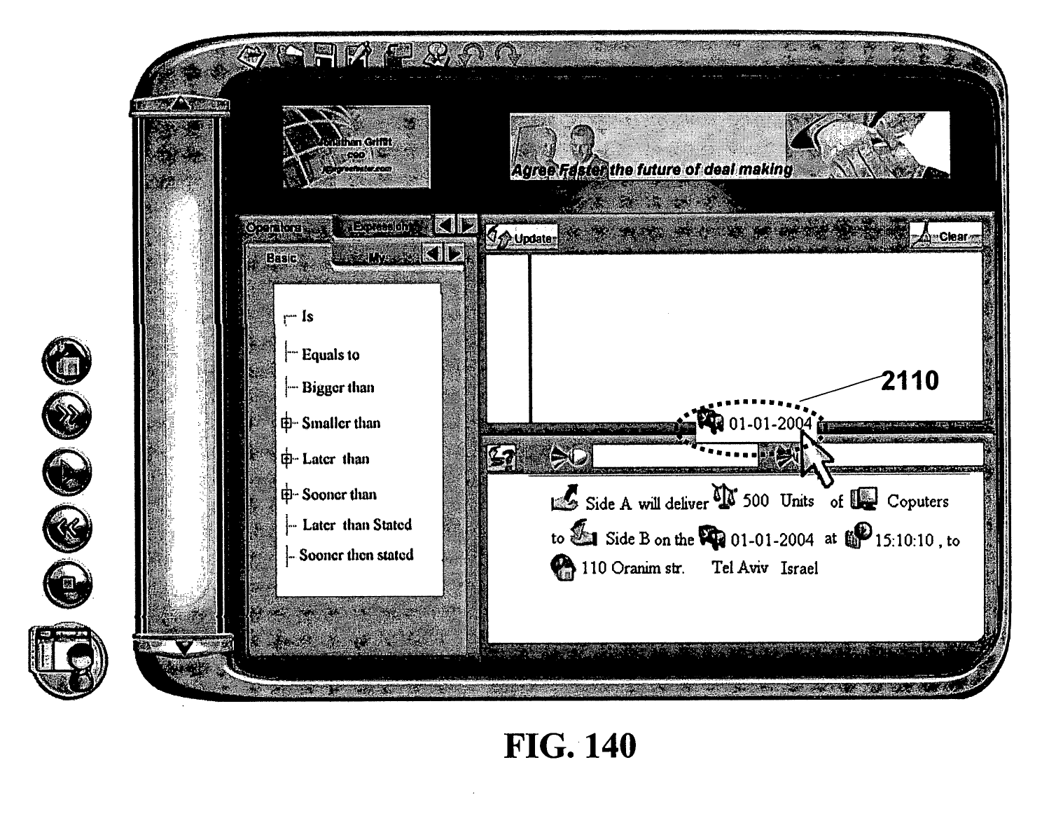

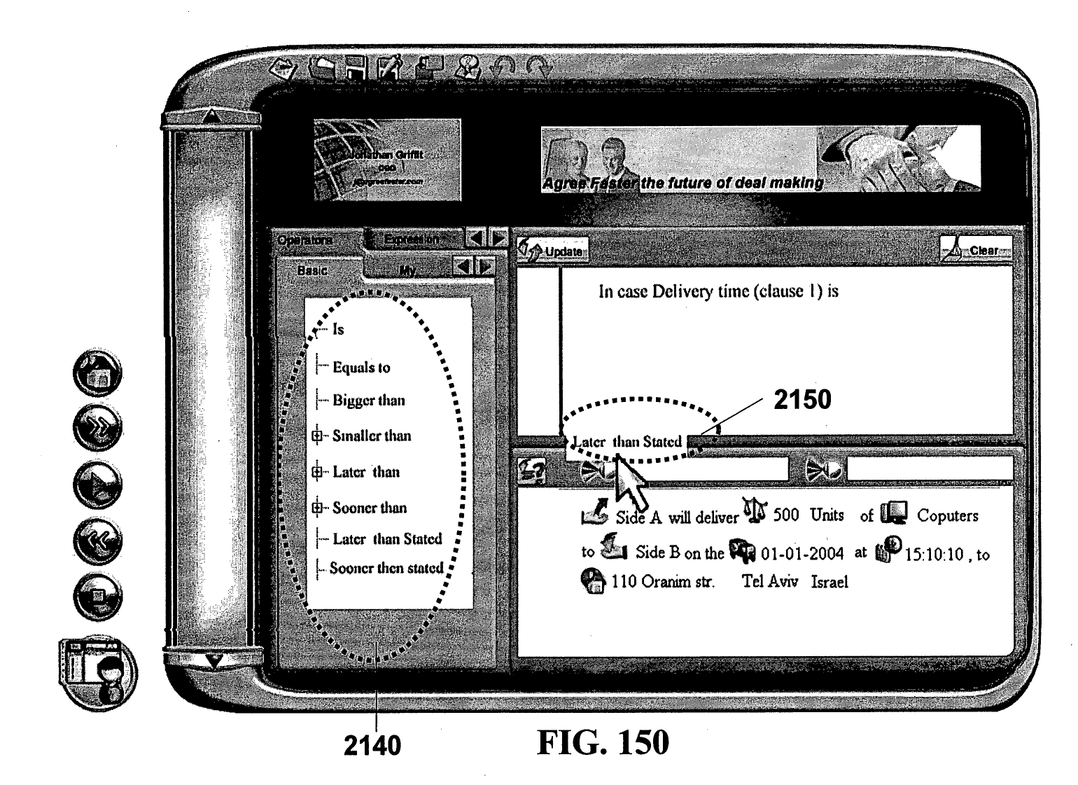

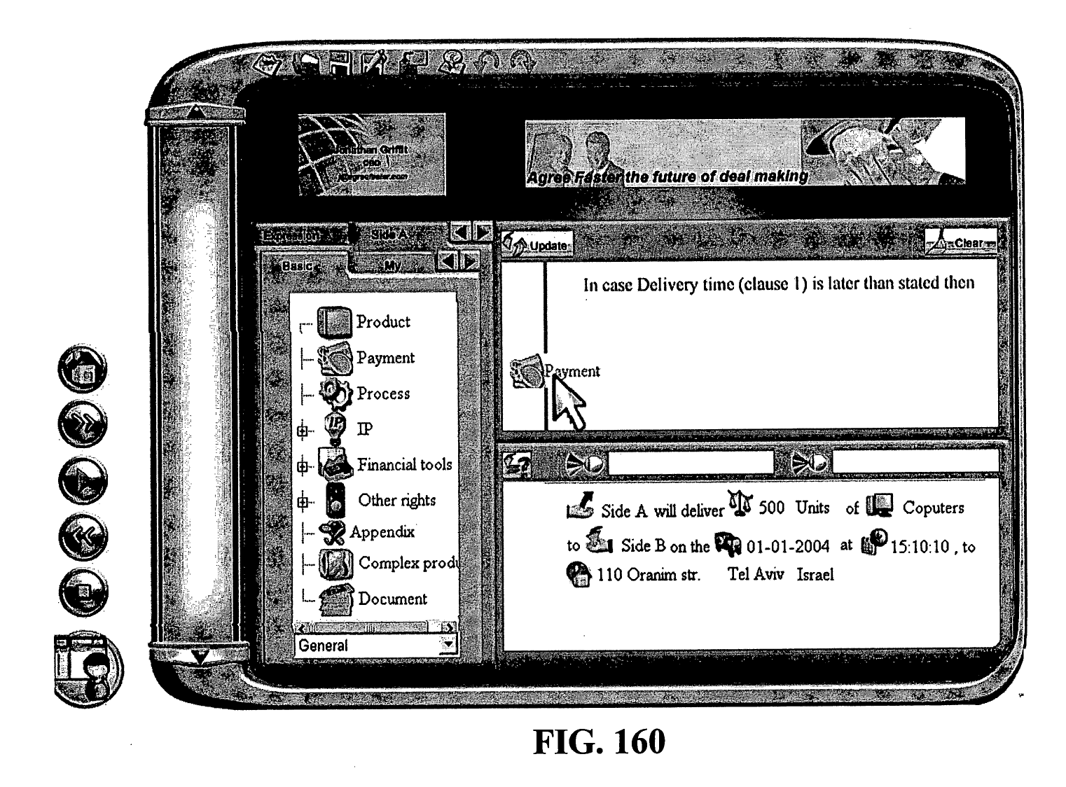

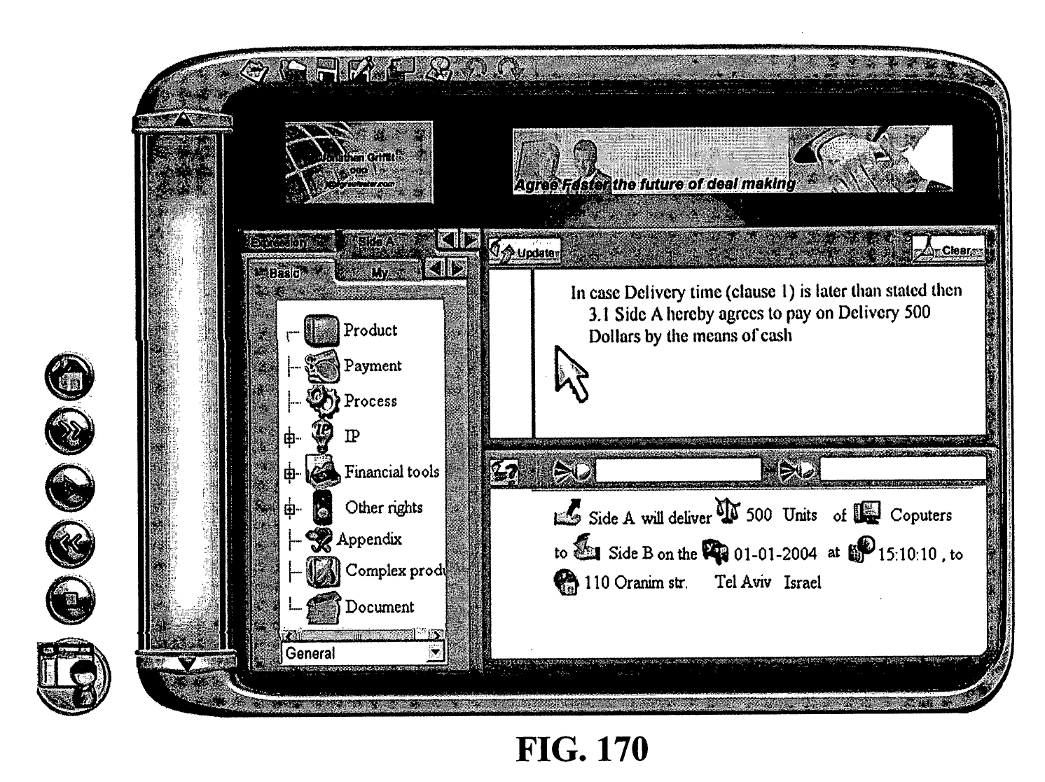

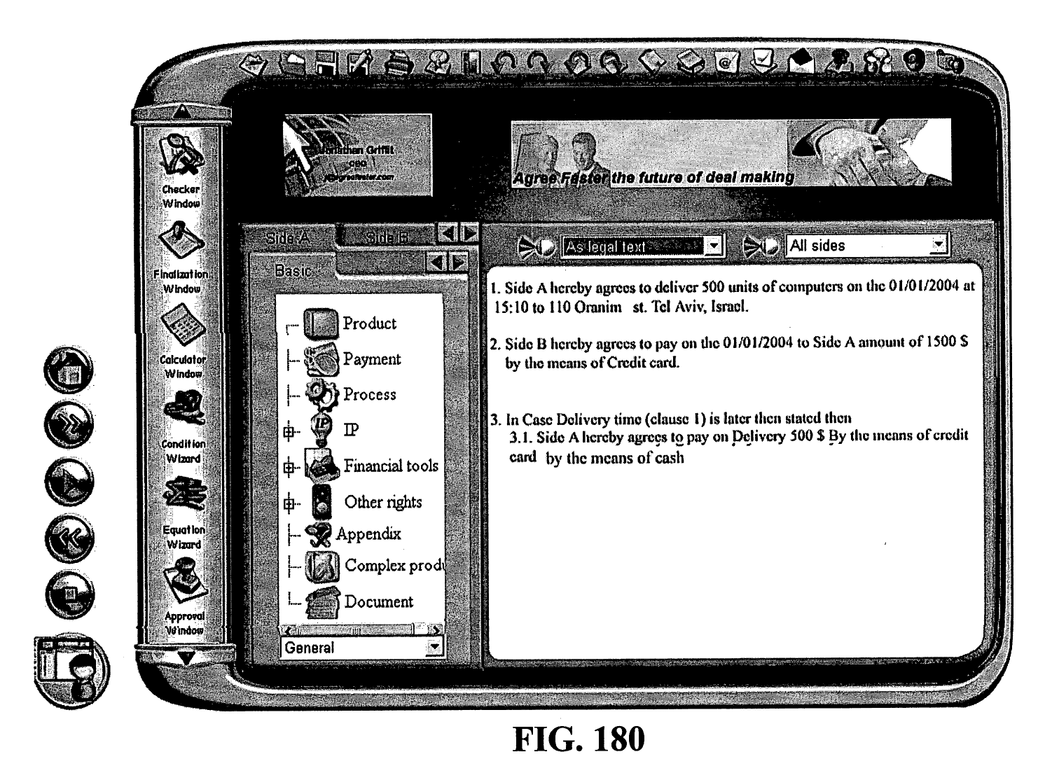

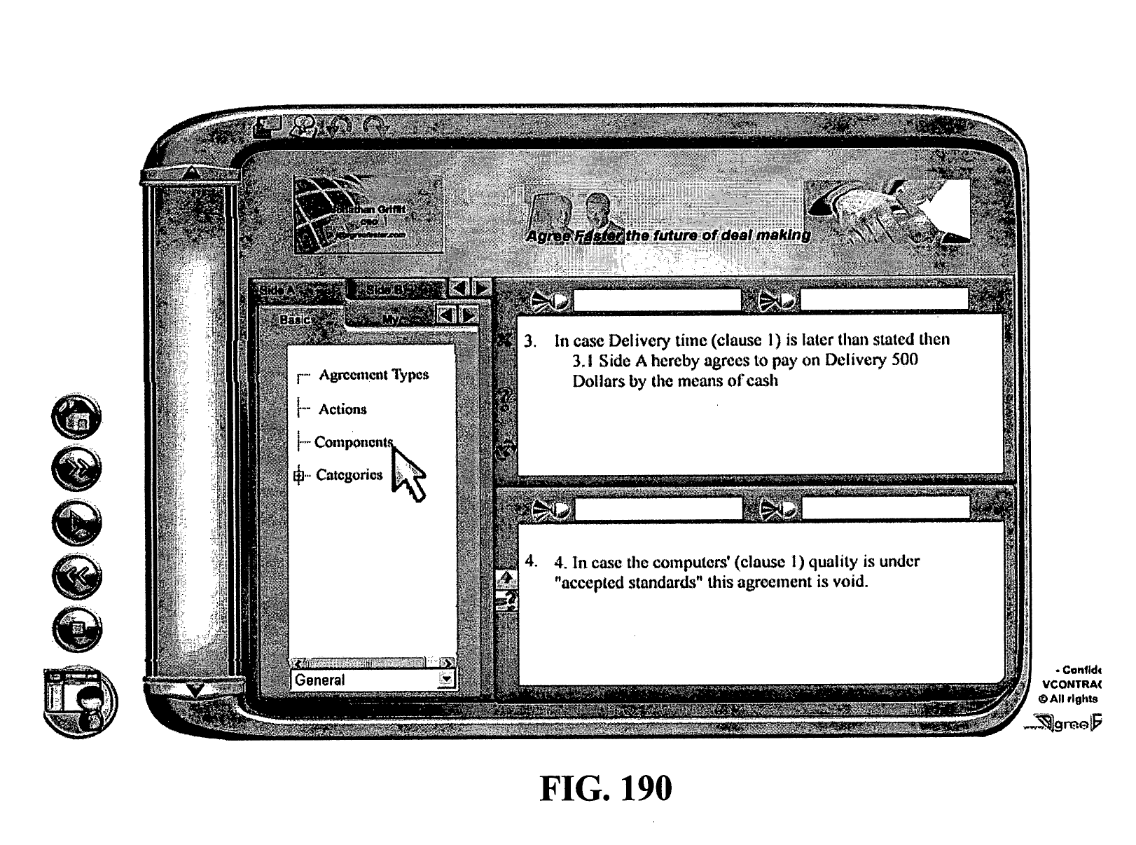

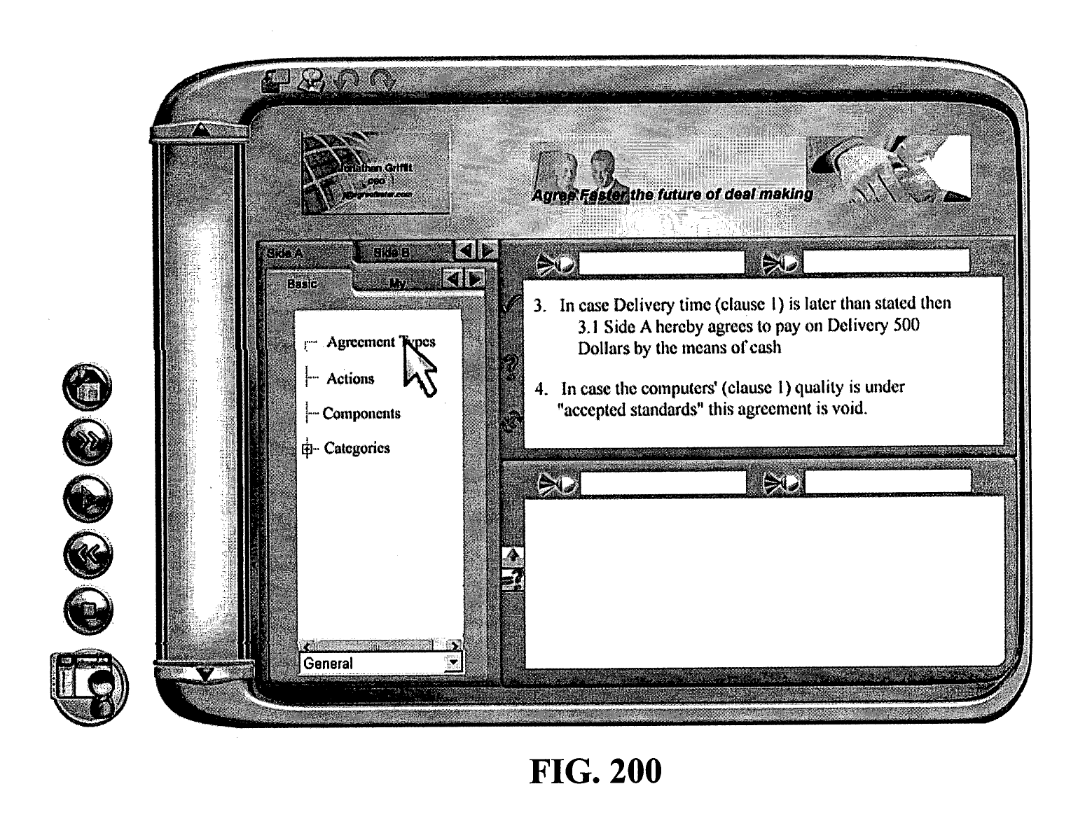

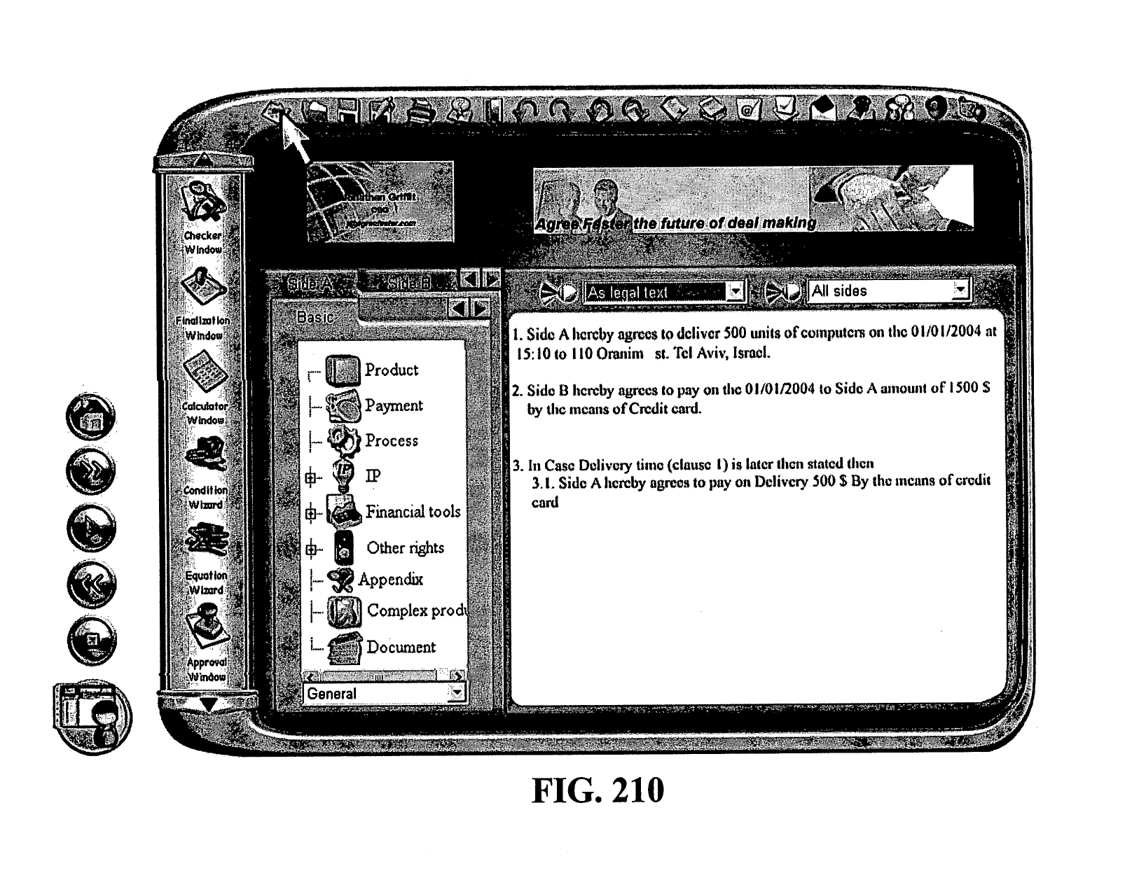

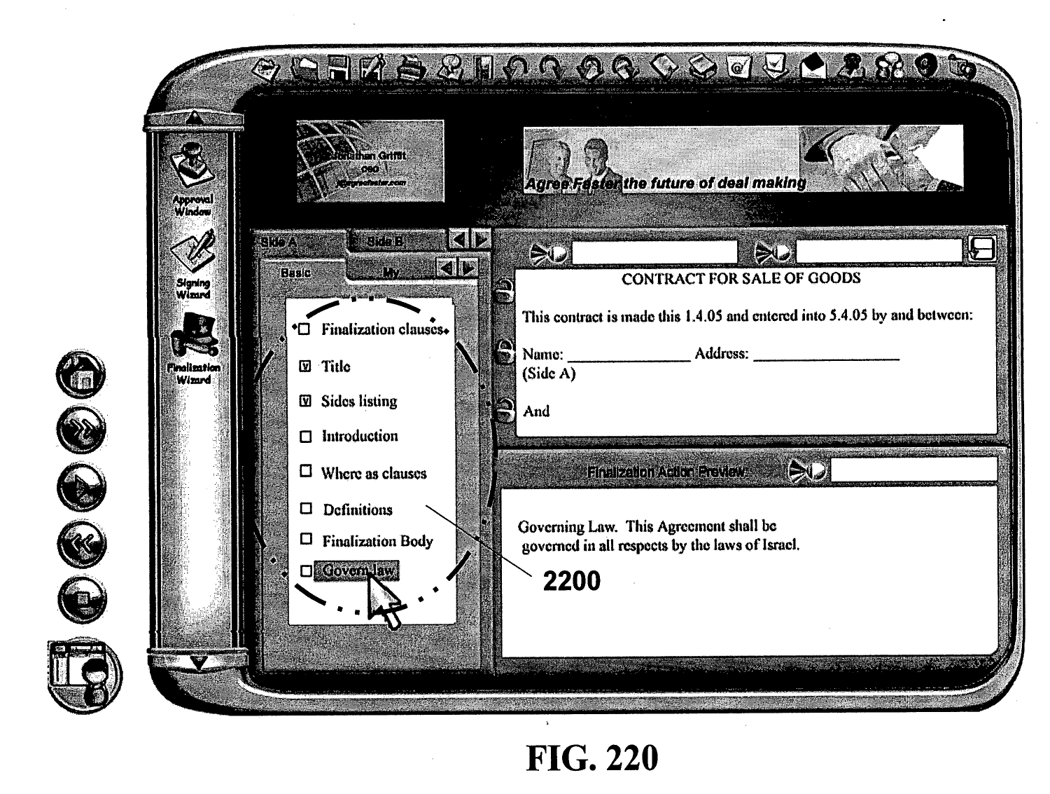

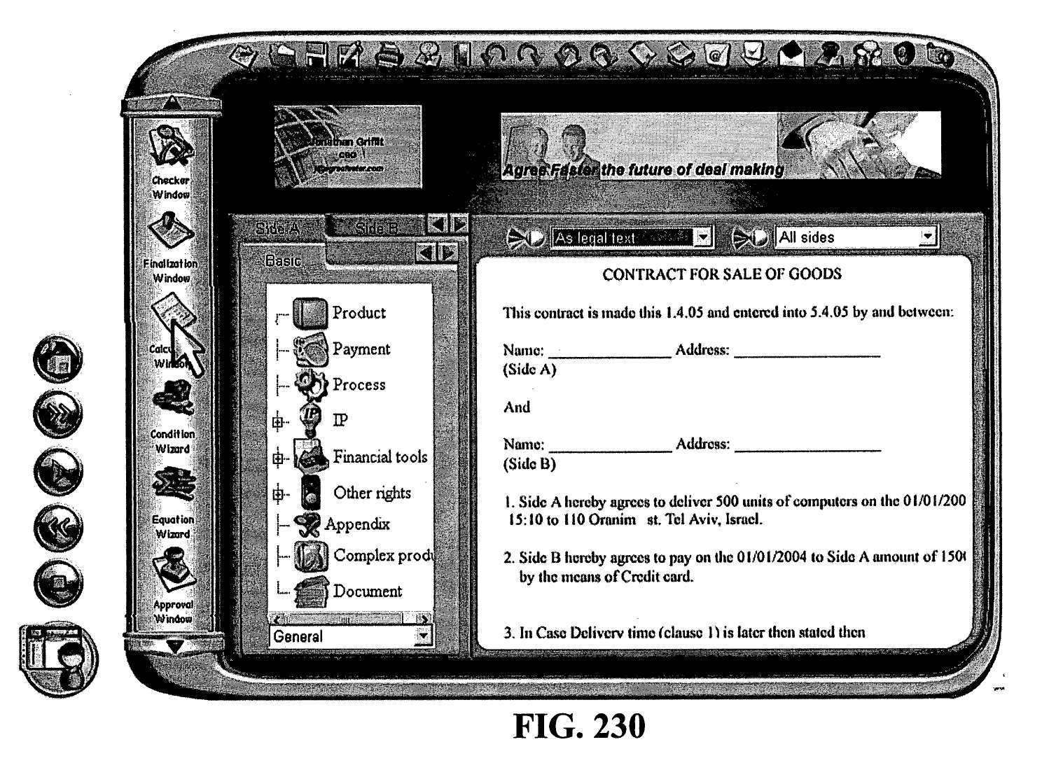

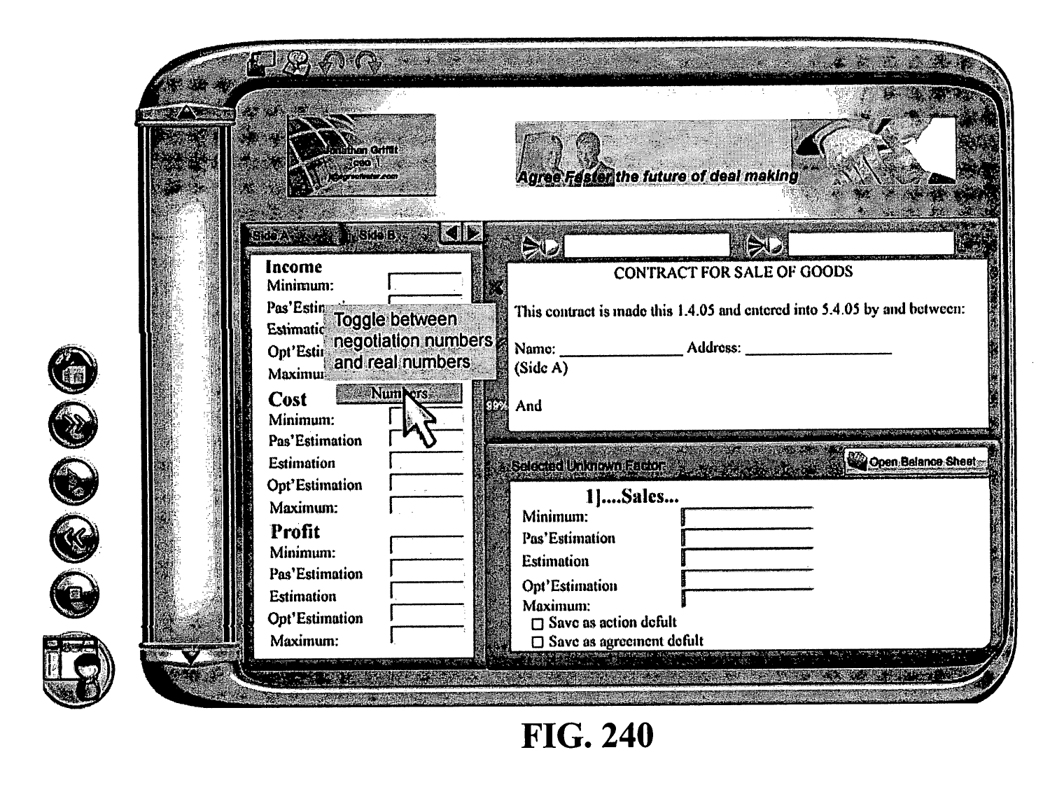

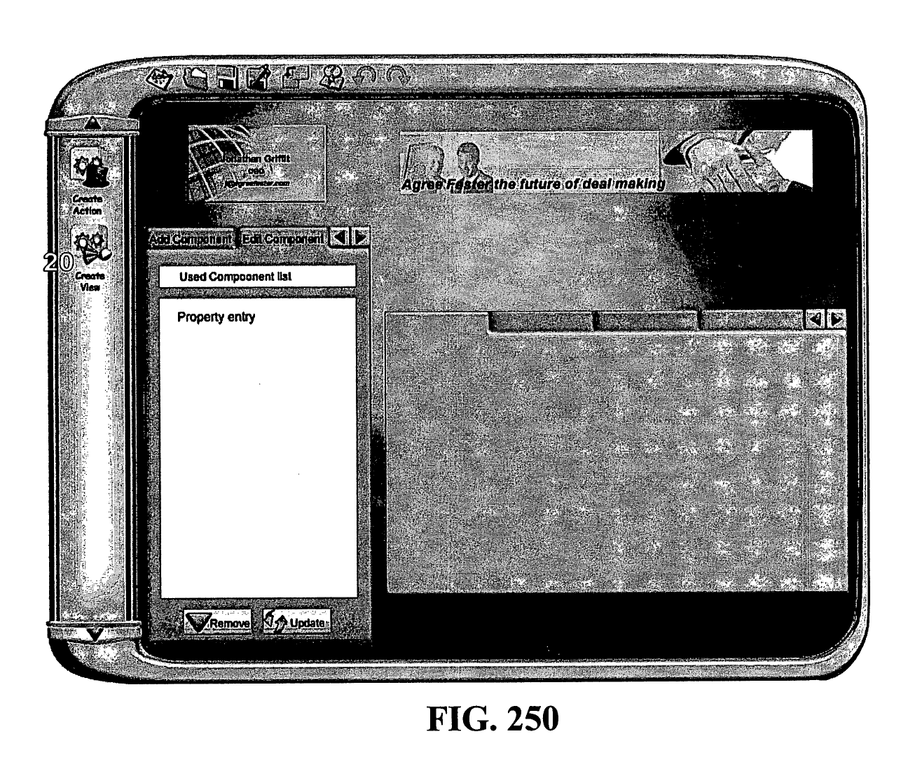

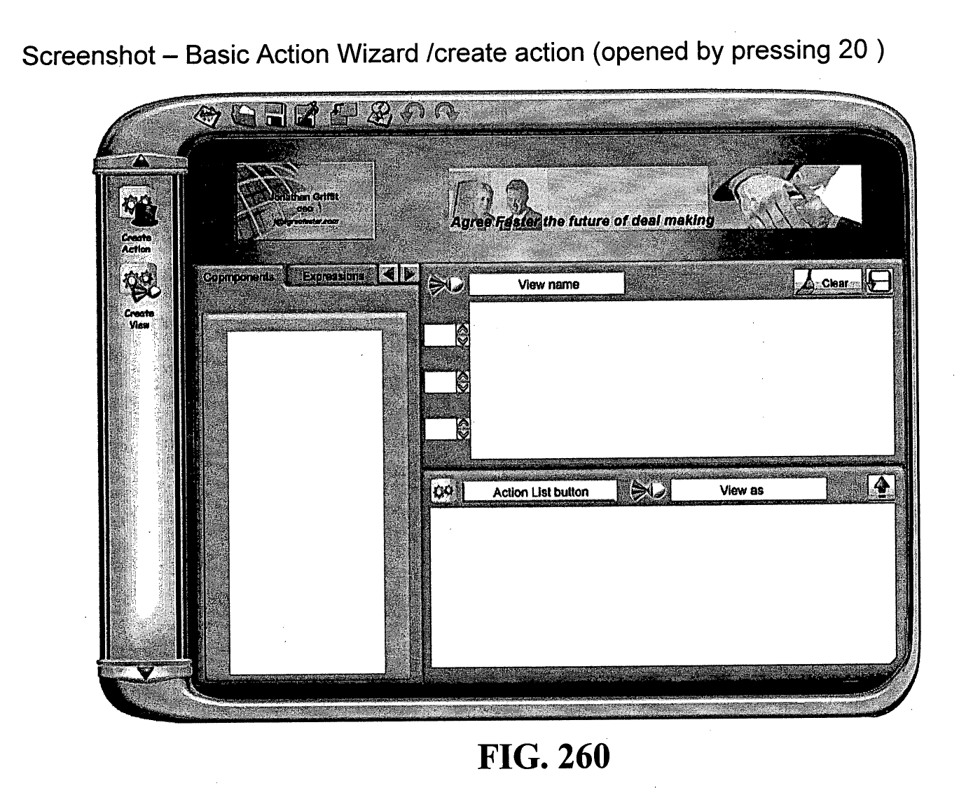

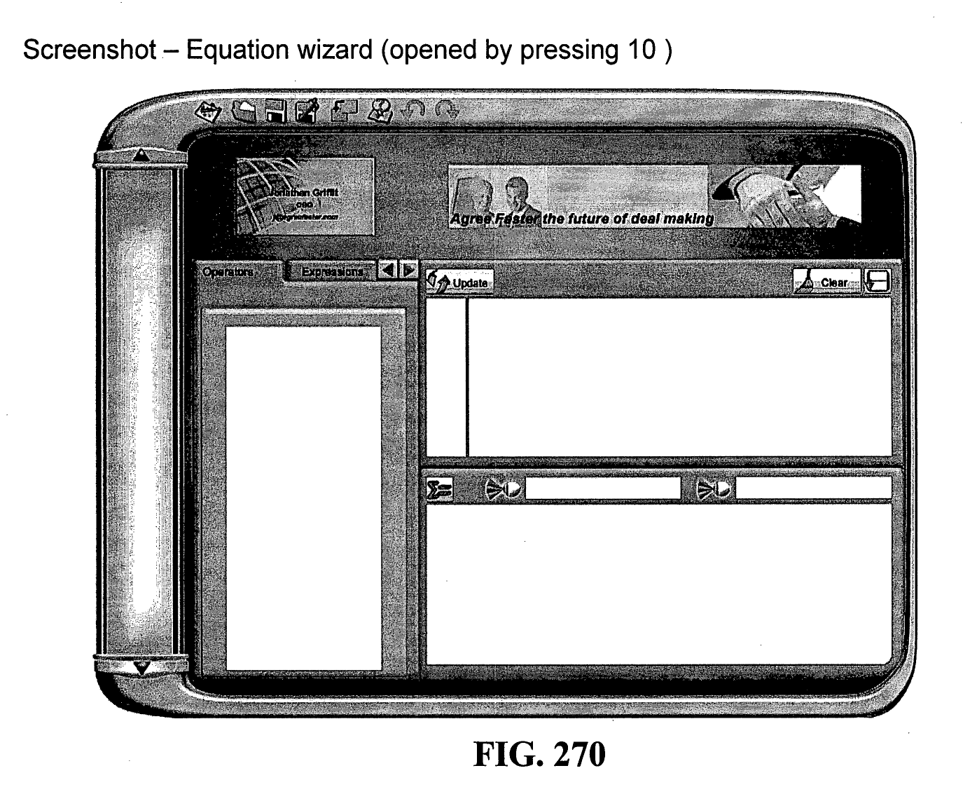

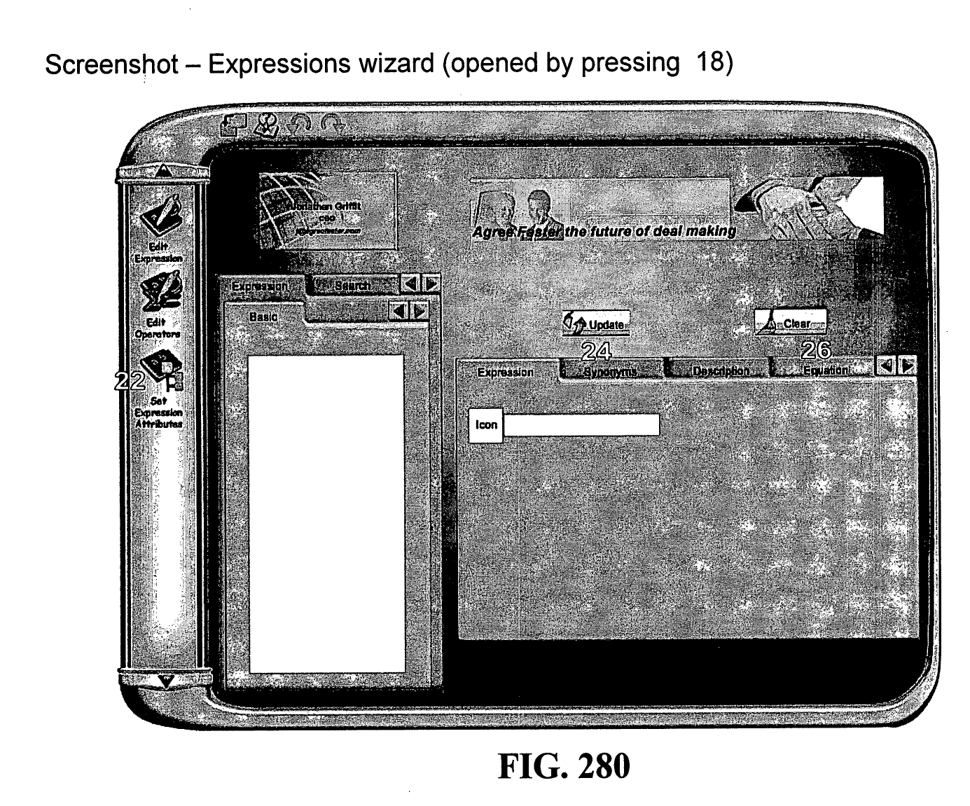

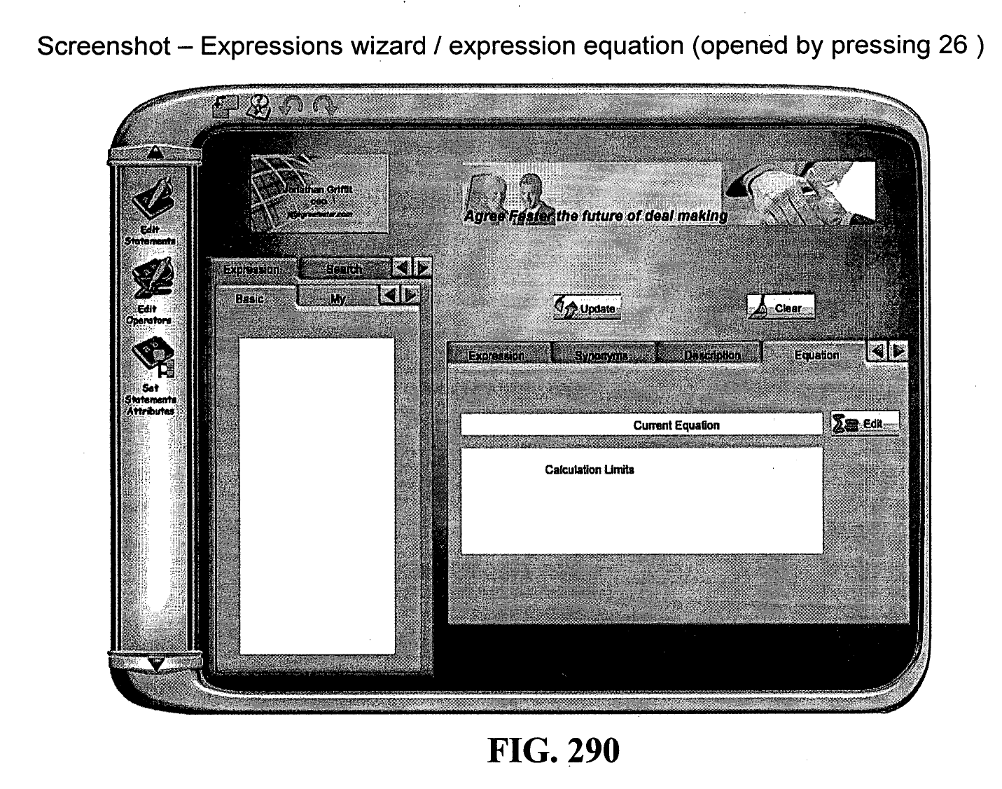

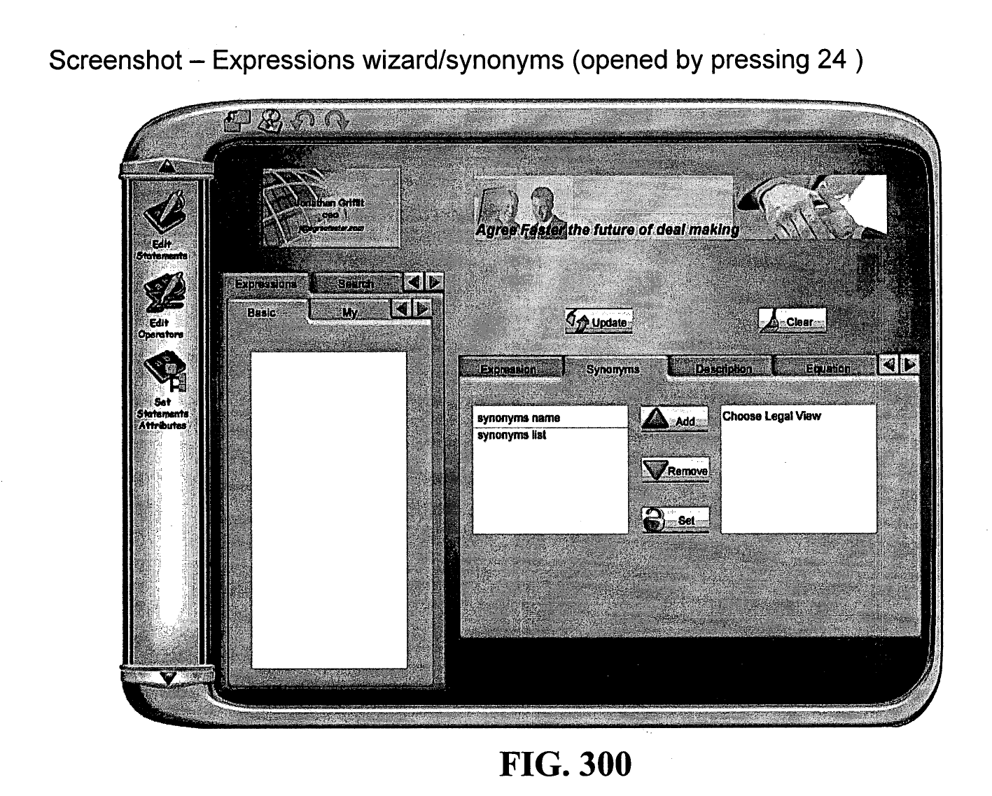

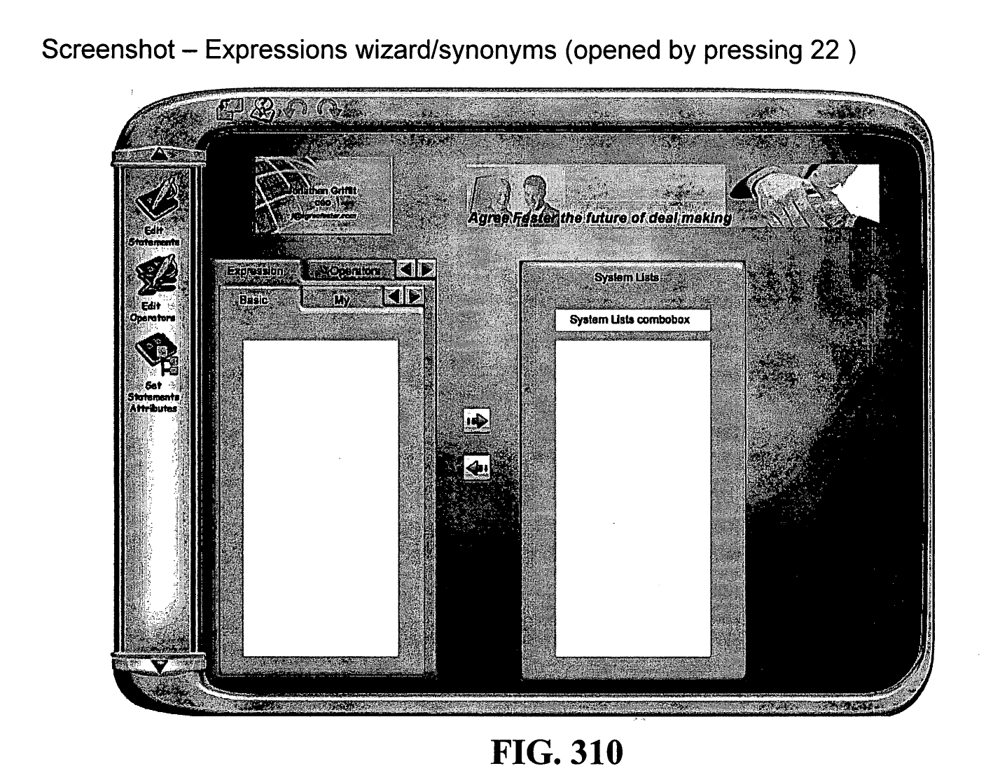

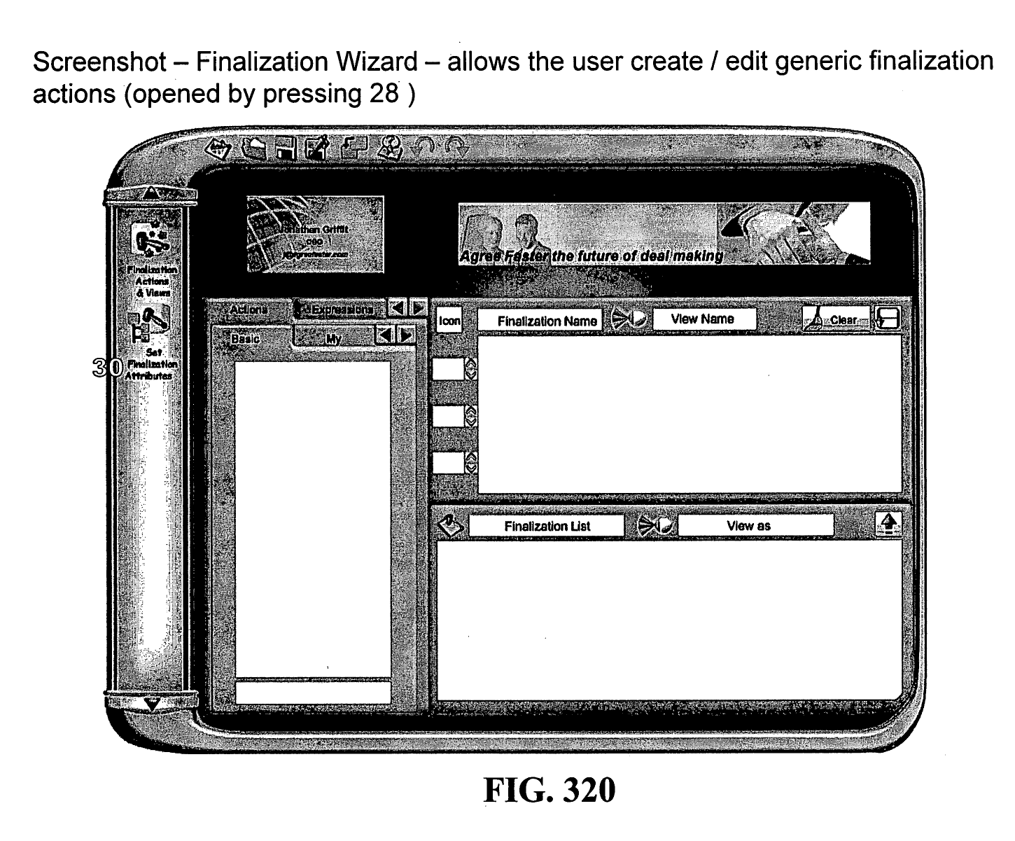

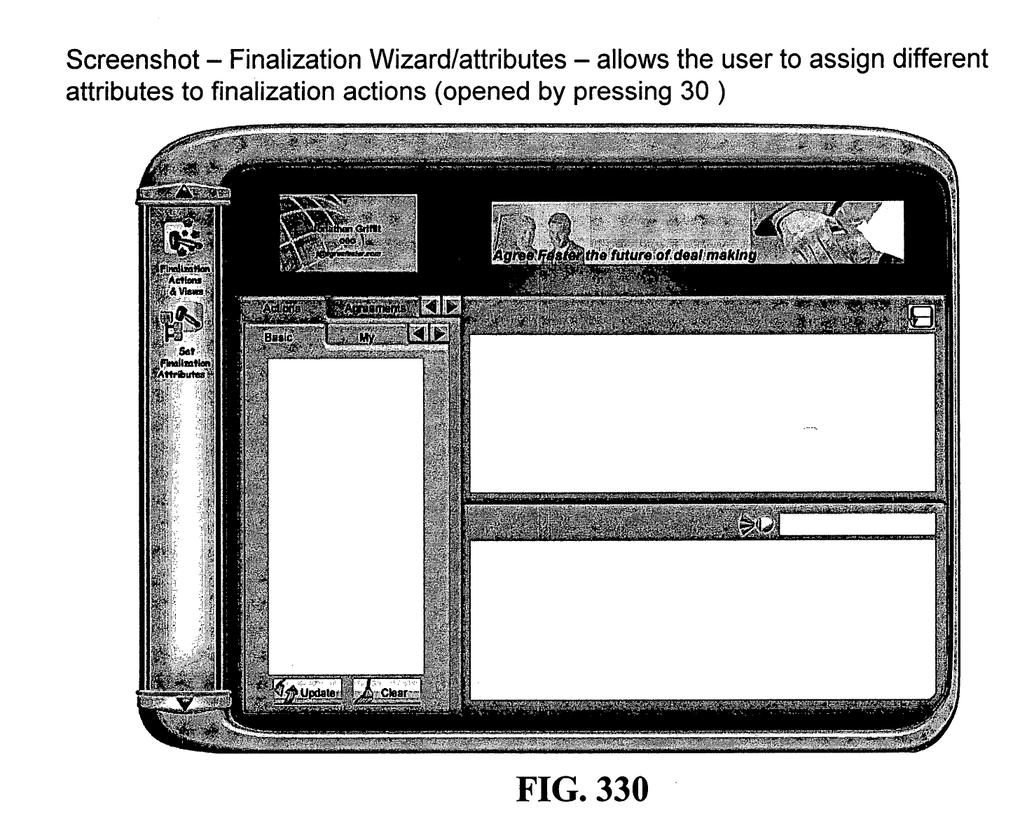

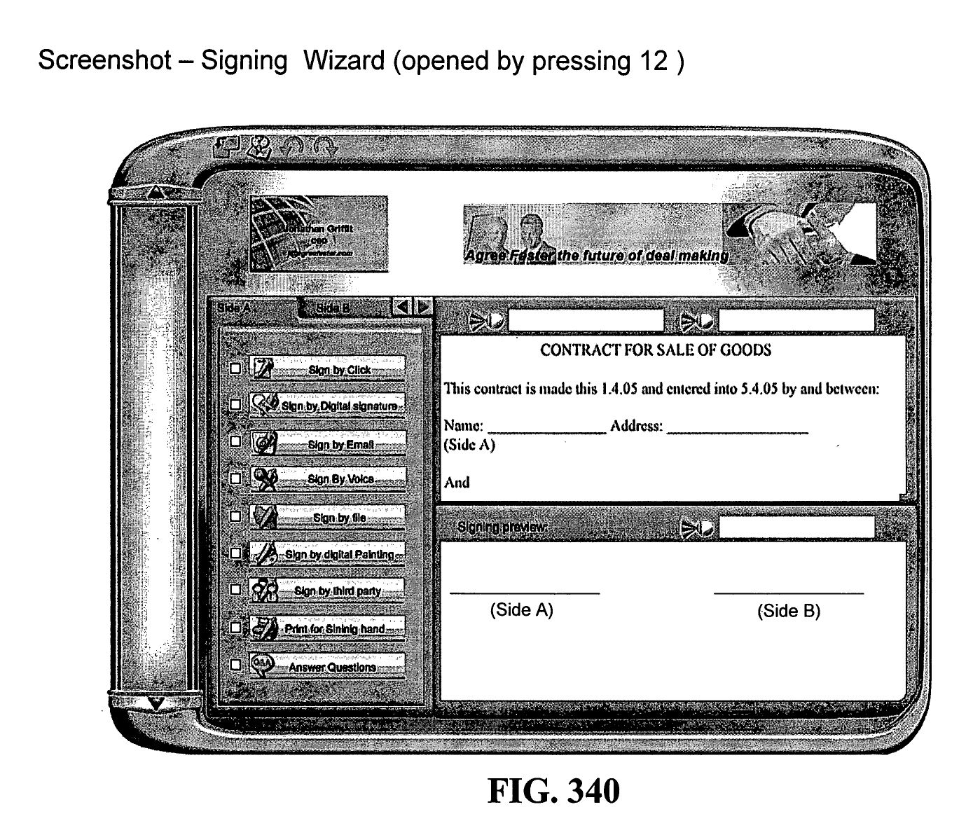

FIG. 20 provides a screenshot of an exemplary input user interface for receiving legal directive objects. One exemplary legal directive object is an object representing a directive for one party to deliver or sell a product to another party. The product legal directive object is represented as the “product” graphical icon 2020 which is dragged from the basic legal directive object menu 2010 and dragged to the work area 2030. With reference to FIGS. 20-50, it will now be described the generation of the formal contract clause “Side A hereby agrees to deliver 500 units of computers on the Jan. 1, 2004 at 15:10 to Oranim st. Tel Aviv, Israel.” In order to generate this clause, first the “Product” object 2020.

As used herein “legal directive objects” are building blocks for individual contract clauses that may be combined to generated clauses. The legal directive objects may be represented graphically (e.g. as a graphic icon) or as text (e.g. a condition object).

One exemplary legal directive object is an action objects such as a directive that the present clause recites a specific actions such as delivery of a product or a transfer of a payment.

One further exemplary legal directive object is a modifier objects such as a legal directive object modifying another legal directive object. One example of a modifier object is a quantity directive object defining a quantity of product to be delivered, stock to vest, etc. For the specific case of defining a number of units, this is referred to as a quantity unit directive object.

Another exemplary legal directive object is a time object. Thus, if a legal clause is referring to a delivery of a product, it is quite possible, though not a requirement, that the same clause will specify the time of delivery. In some embodiments, the time object is received without any connection to where the time condition will appear in the eventual generated text clause. Thus, in some embodiments, the legal directive objects are abstract legal directive objects which are divorced from specific contract text, for example, through a user interface separate from the interface where a clause or text template for a clause is presented.

It is noted that area 2070 provides tabs for selecting an active contract party from a plurality of said contract parties. In FIG. 20, the active contract party is “Side A,” which will be the active contract party of the clause.

Optionally, the tab window is generated for each legal directive object (e.g. action object) and includes components specific to the selected object (e.g. action object). Thus, for each object selected, a different menu (e.g. tab) providing a plurality of options (e.g. modification objects) for modifying the clause is presented in accordance with the selected object.

It is noted that many action legal directive objects, in this example (e.g. product, complex product) function as “clause initiating legal directives” as opposed to “modifying directives” (e.g. date) which function as “clause modifying legal directives.”

As shown in FIG. 20, the work area 2030 includes several tabs 2040A for selecting and/or specifying legal directive objects. Taken collectively, the tabs 2040A in the work area 2030 function as a template defining which requisite and/or optional legal directive objects need to be received in order to specify the clause. Thus, the template of 2040 is operative to receive the following legal directive objects in order to generate the clause: Name/Product, Quantity, Time and Date, Place. Is it noted that these directive objects are merely examples of appropriate legal directive objects, and are not provided as limiting. Other exemplary legal directive objects include value, currency, stages, and parts.

In general, legal directive object templates define optional and/or requisite objects of an individual contract clause. Thus, although the legal directive object template for the particular clause as presented in FIG. 20 is a collection of labels for each legal directive object located in fixed relation relative to each other, this should not be construed as a specific limitation of the present invention. In some embodiments, the legal directive object template for a particular clause can, for example, include sequential requests for requisite or optional legal directive objects.

Other objects in the basic legal directive object menu 2010 include “Process” for specifying a clause or formal contract text related to a “Process.” One example to a process is an agreement to provide a service, e.g. to repair a house or to maintain a fleet of vehicles. Another icon is “Complex Product.” In some embodiments, selection of “Complex Product” is operative to generate a clause related to (e.g. whose subject is) a complex product, which is specifying by a separate user interface operative to specify parameters of the Complex Product. In one example, the Complex Product is a computer or a plurality of computers, and specifying the product is carried out through, for example, a user interface for specifying CPU speed, quantity of memory, CD/DVD speed and the like. Another icons is “Financial Tools.” In one example, an agreement is a commercial agreement related to financial instruments (e.g. stocks, stock options) such as an Employment Agreement with stock options or a commercial agreement between two banks to trade financial instruments. Selection of the “Financial Tools” icon is operative to create a clause related to (e.g. whose subject is) a financial instrument or plurality of financial instrument whose parameters are specified through a user interface.

Associated with the “Name Icon” is a text box for specifying exactly which product is being delivered. The specific product, “Computers” can either by typed in or selected from a plurality of possible products. According to specific template, a specific number of products need to be delivered, and the “Quantity” legal directive object can be specified by selecting the “Quantity” tab from the template 2040 (see FIG. 30), which accesses a form for selecting a specific number and specific units. Furthermore, according to (FIG. 40) the “Time and Date” legal directive object, a form is provided for entering the appropriate time, date, format and time zone. After specifying the appropriate legal directive objects, the system is operative to generate the implicit formal contract text. For specific clause shown in FIG. 50, the implicit contract text is “hereby agrees to deliver”, “of,” “on the”, “at,” and “to.”

It is appreciated that any combination of legal directive objects appropriate for generating clauses of a contract are appropriate for templates of the present invention, and thus the specific template of FIGS. 20-50 is provided as an illustrating example.

With reference to FIGS. 60-80, it will now be described the generation of the formal contract clause “Side B hereby agrees to pay on the Jan. 1, 2004 to Side A amount of 1500 $ by means of Credit Card.” In FIG. 60, the active contract party is “Side B,” which will be the active contract party of the clause. In order to generate the clause, the “Payment” 2050 icon is selected from the basic legal directive object menu 2010 and dragged to the work area 2030. This activates legal directive object template 2040B for the particular “Payment” clause, where the active contract party of the clause is Side B. In FIG. 70, the “Amount” legal directive object is defined using the provided form.

Clause 2 in the work area 2030 of FIG. 80 shows the clauses generated by the legal directives object received. It is noted that embodiments of the present invention provide a contract text view presenter for presenting the contract text according contract text view. For the particular embodiment of FIGS. 80-90, the contract text view is selected from a plurality of possible contract text views using a contract view selection box 2090. Thus, as shown in FIG. 90, exemplary contract text views include “Icons and Numbers,” “As Icons and Text,” “As colored simple text,” “As colored legal text,” “As legal text,” “Time Line Graphs,” “Profits graphs,” and “Icons in Text.”

It is noted that, in some embodiments, the specific plurality of views provided is customizable, and the user can add additional views. For example, a law office in Eastern Europe could add views for “Ukrainian Law”, “Polish Law” and “Latvian Law”. In another example, different lawyers in a single office have different contract drafting writing styles (e.g. different implicit formal contract text), and possible customizable views are, for example, “Advocate Smith Style” and “Advocate Jones Contract Style.”

The present inventor has found that the ability to toggle between “legalese” text and “simple text” (as shown in FIG. 100) is a powerful tool for allowing non-practioners (e.g. business personal more considered with economic consequences of a contract rather than the specific legal terms) unfamiliar with contract legal terminology to view and understand drafted clauses.

In some embodiments, the contract text presenter is operative to present text according to the formalities of one or more jurisdictions (e.g. United Kingdom, Australia, United States, etc). This obviates the need to re-write contract clauses compliant with the specifics of each jurisdiction.

FIG. 110 provides an exemplary image of the “Icons in Text” view of legal clauses. The present inventor has found that the “Icons in Text” view allows for quick reading of legal clauses, especially by non-practitioners.

Furthermore, as will be shown with reference to FIGS. 130-180, according to some embodiments, legal directive objects for generating or deriving a second clause are obtainable by dragging and dropping from “Icons in Text” of a first clause. Thus, according to some embodiments, the clause generator is operative to generate a second clause in accordance in part with a first clause.

It is noted that in some embodiments, the second clause can also be generated by dragging and dropping the text variables themselves and not only the icons.

FIGS. 130-170 provide images describing the generation of the clause “In case Delivery time (clause 1) is later than stated then 3.1 Side A hereby Agrees to pay on Delivery 500 Dollars by the means of cash.” At least one of the legal directives for building or generating this clause is taken from a different clause, namely that clause “Side A will deliver 500 units of computers on the Jan. 1, 2004 at 15:10 to Oranim st. Tel Aviv, Israel.” This is illustrated in FIG. 140 wherein the legal directive objective 2110 “Delivery Time Jan. 1, 2004” is dragged from the lower window 2100 to the upper window 2120.

Referring to FIG. 150, in order to build this clause legal directive objects can be combined with each other and the resultant clause is generated according to received legal directive objects as well as condition objects, which themselves are a type of legal directive object. As illustrated in FIG. 150, each condition object is selectable from a plurality of condition objects 2140. The condition object is dragged into the upper window 2120 in which the new clause is being built or generated. It is noted that the condition object shown in FIG. 150 has a textual rather than a graphical representation.

Thus, in general, it is noted that although legal directive objects in some embodiments have are graphically represented (e.g. using an icon), this is not a limitation of the present invention.

FIGS. 140 and 150 provide examples of an interface for defining for specifying a second clause (e.g. “In case Delivery time (clause 1)”) in accordance, at least in part, with a first clause (e.g. Side A will deliver 500 Units of Computers to Side B on the Jan. 1, 2004 at 15:10:10 to 100 Oranim Str. Tel Aviv Israel). Thus, in some embodiments, the present invention provides a interface for defining one legal clause in accordance, at least in part, with another clause. In some embodiments, the generation or specification of the first clause is operative to trigger or configure the user interface to define the second related clause (e.g. in this example, the “Conditional Clause” relates to, and in a sense modifies, the first “Action Clause”).

In FIG. 160, the icon 2050 representing the Payment legal directive object is dragged into the work area 2030 for further building the clause. The specifics of the payment object are received (500 dollars by means of cash) through as in FIG. 70. The final clause (clause 3) generated by the clause generator is shown in FIG. 180.

FIG. 190 shows a clause suggested by the system displayed in the lower window 2100. This clause is suggested with previously received legal directive objects and other generated clauses. The user has the option to accept or not accept the suggested clause, and in FIG. 210 this clause is accepted.

It is noted that the suggested clause (or part of clause) is made in accordance with contract logic embedded in the system. Contract logic is not limited to suggestions of clauses and/or portions of clauses and/or legal directive objects. In some embodiments, contract logic is embedded in a scenario analysis engine and/or a contract logic engine for identifying invalid or potentially invalid contract elements (e.g. clauses, portions of clauses, legal directive objects) and/or a suggestion engine.

In some embodiments, contract logic is based upon a combination of natural language logic, contract heuristics (e.g. which patterns of words or legal directive objects and/or verbal motifs are found in contracts). In some embodiments, the contract heuristics is supplied in an optional database providing data about contract structure, prevailing law in certain jurisdictions, etc.

Thus, according to some embodiments, the presently disclosed invention includes a contract logic engine operative to analyze contract logic associated with received legal directive objects and/or generated contract clause(s).

In some embodiments, the contract logic is used in a contract validity engine that is operative to identify invalid or potentially invalid contract elements such as clauses, portions of clauses, legal directive objects. Exemplary is invalid contract elements include contradicting conditions, circular conditions, an inappropriate contract party and illogically redundant conditions.

One example of a contradicting condition is where a first clause reads that “if delivery is late, Side A will pay Side B $70” and a second clause reads that “if delivery is late, no penalty whatsoever will be paid by Side A.”

One example of a circular condition is where clause 17 reads “in the event of force majeure, the conditions of clause 26 will apply” while clause 26 reads “in the event of force majeure, the conditions of clause 17 will apply.”

One example of an inappropriate contract party is where a contract has two parties or sides (e.g. side A and side B) and a specific clause refers to a side or party that is not included the list of contract sides or parties (e.g. side C).

One example of an illogically redundant condition is where a first clause reads that “if delivery is late, Side A will pay Side B $70” and a second clause reads that “if delivery is late, Side A will pay $200.” This is not necessarily a contradiction, as it is theoretically possible for Side A to pay both $70 and $200. Nevertheless, this is illogically redundant.

In some embodiments, upon identifying invalid contract elements, a warning is generated and/or the system will not generate a clause or other contract element.

Some embodiments of the present invention provide a finalization engine for generating finalization clauses. In some embodiments, the finalization clauses are generated in accordance with other clauses of the contract, e.g. action clauses.

In some embodiments, the finalization engine for automatically adding or for tailoring finalization clauses includes a user interface for receiving finalization directives, such as depicted in FIG. 220. The finalization includes a finalization menu 2220 for selecting of finalization clause types to add or customize. In FIG. 220, the “Govern law” clause type was selected, and the laws of Israel were chosen as the governing law.

FIG. 230 shows another view of the generated contract.

FIG. 240 show an interface for receiving numbers where the clauses and/or contract text are generated according to the numbers entered in the form. Furthermore, the form of FIG. 240 allows for both received numbers to be inserted in the generated clauses and/or contract text as well as calculated numbers to be inserted.

One example of FIG. 240 where a calculated number is inserted into contract text is where businessman wants to make a minimum profit on a deal. The businessman knows his and her cost (or cost estimation) and thus enters these figures into the form, as well as his or her desired profit. The system is operative to thus calculate the cost numbers and to employs these calculated numbers when generating the clauses.

The presently disclosed systems and methods are operative for generating any type of formal contract text. Exemplary contracts include but are not limited to Asset Purchase Agreements, Bankruptcy Agreements Business Separation Agreements, Bylaws, Change in Control Agreements, Collaboration Agreements, Construction Agreements, Consulting Agreements, Contribution Agreements, Credit Agreements, Debentures, Deferred Compensation Plans, Dissolution Plans, Employee Stock Purchase Plans, Employment Agreements, Escrow Agreements, Excess Benefit Plans, Exchange Agreements, Franchise Agreements, Funding Agreements, Guaranties, Incentive Plans, Incorporation Certificates, Indemnification Agreements, Indentures, Intercreditor Agreements, Joint Venture Agreements, Labor Agreements, Leases—Equipment, Leases—Real Property, License Agreements, Limited Liability Company Agreements, Loan Agreements, Management Agreements, Manufacturing and Supply Agreements, Merger Agreements, Non-Competition/Non-Disclosure Agreements, Note Purchase Agreements, Operating Agreements, Participation Agreements, Partnership Agreements, Pledge Agreements, Project Finance Agreements, Promissory Notes, Proxy Agreements, Receivables Agreements, Registration Rights Agreements, Research and Development Agreements, Restricted Stock Agreements, Restructuring Agreements, Retirement Plans, Rights Agreements, Sales and Marketing Agreements, Security Agreements, Services Agreements, Settlement Agreements, Severance Agreements, Severance Plans, Shareholder Agreements, Shareholders' Rights Agreements, Sponsorship Agreements, Stock Option Agreements, Stock Option Plans, Stock Plans, Stock Purchase Agreements, Subordination Agreements, Tag-Along Agreements, Tax Agreements, Trust Agreements, Underwriting Agreements, Voting Agreements, and Warrant Agreements.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1) A system for formal contract drafting, the system comprising:
a) an input user interface for receiving legal directive objects;
b) individual clause generator for generating formal contract clauses from said legal directive objects.

2) The system of claim 1 wherein generation of said individual formal contract clause includes generation of implicit formal contract text.

3) The system of claim 1 wherein said contract clauses are generated using contract logic embedded in said clause generator.

4) The system of claim 1 wherein said interface includes a legal directive object template defining optional or requisite objects of an individual contract clause.

5) The system of claim 1 wherein at least one legal directive object is selected from the group consisting of an action object, a modifier object, a quantity directive object, a quantity unit directive object, a delivery directive object, a time object, a date object, and a legal condition object.

6) The system of claim 5 wherein said action object is selected from the group consisting of a product object, a payment object and a payment method object.

7) The system of claim 1 wherein said input user interface provides a mechanism for selecting an active contract party from a plurality of said contract parties, and a said generated clause relates to said active contract party.

8) The system of claim 7 wherein a subject of said generated clause is said active contract party.

9) The system of claim 7 wherein said generated clause relates to obligations taken on by said active party.

10) The system of claim 1 wherein said legal condition object is a condition operator selected from the group consisting of a quantity condition operator, a quantity comparison condition operator, a conditional condition operator, a time condition operator, and a size condition operator.

11) The system of claim 1 wherein said generated clause is selected from the group consisting of an action clause, a condition clause and a finalization clause.

12) The system of claim 1 wherein at least one said legal directive object is definable using a legal object definition form.

13) The system of claim 1 wherein at least one said legal directive object is represented in said input user interface by a graphical icon.

14) The system of claim 13 wherein dragging of a said graphical icon sends information to said individual clause generator for said clause generation.

15) The system of claim 1 wherein said clause generator is operative to derive one said contract clause from at least one other said contract clause and contract logic.

16) The system of claim 15 wherein said derived contract clause is a finalization clause.

17) The system of claim 15 wherein said clause generator is operative to include within said derived clause a condition dependent on said at least one other said contract clause.

18) The system of claim 1 wherein at least one said legal directive object is selectable from a plurality of legal directive objects.

19) The system of claim 1 further comprising:
d) a contract logic analyzer for analyzing validity of at least one of a said received legal directive object, said generated contract clauses and said built formal contract text.

20) The system of claim 1 further comprising:
c) a formal contract text builder for building a formal contract text from a plurality of said generated contract clauses.

21) The system of claim 20 wherein said formal contract document builder includes a finalization engine for generating finalization clauses of said formal contract document.

22) The system of claim 1 further comprising:
c) a contract text view presenter for presenting legal text related to said generated contract clause in accordance with a presentation view selectable from a plurality of contract text presentation views.

23) The system of claim 20 wherein said at least one contract text view is selected from the group consisting of a view mixing icons and numbers, a view mixing icons and text, an informal text view, a colored informal text view, and a business logic view.

24) The system of claim 23 wherein said business logic view includes at least one of a time line graph, and a profit graph.

25) The system of claim 22 wherein a said contract text presenter is operative to present said formal contract text according to formalities of a jurisdiction selectable from a plurality of jurisdictions.

26) The system of claim 1 further comprising:
c) a contract logic engine for analyzing contract logic associated with at least one of said received legal directive objects and said generated clause.

27) The system of claim 1 further comprising:
d) a contract validity engine for to identifying legally invalid or potentially invalid contract elements associated with said generated contract clauses.

28) The system of claim 27 wherein said invalid contract elements are selected from contradicting conditions, circular conditions, an inappropriate contract and illogically redundant conditions.

29) The system of claim 1 further comprising:
c) scenario analysis engine for facilitating scenario analysis in accordance with legal directive objects selected from the group consisting of said received legal directive objects and candidate legal directive objects.

30) The system of claim 1 further comprising:
c) a suggestion engine for generating suggestions selected from the group consisting of suggested clauses and suggested legal directive objects.

31) A method of formal of contract drafting, the method comprising:
a) receiving through a user interface a specification of a plurality of legal directive objects;
b) generating at least one individual formal contract clause from said legal directive objects.

32) A computer readable storage medium having computer readable code embodied in said computer readable storage medium, said computer readable code comprising instructions for:
a) receiving through a user interface a specification of a plurality of legal directive objects;
b) generating at least one individual formal contract clause from said legal directive objects.
